(19) United States
(12) Patent Application Publication
(10) Pub. No.: US 2026/0020045 A1
(43) Pub. Date: Jan. 15, 2026

(54) DUAL CONNECTIVITY OR CARRIER AGGREGATION FOR USER EQUIPMENT WITH COOPERATION

(71) Applicant: QUALCOMM Incorporated, San Diego, CA (US)

(72) Inventors: Mohamed Atef Abdelazim SHEHATA, Lannion (FR); Diana MAAMARI, San Diego, CA (US); Mickael MONDET, Louannec (FR); Prashanth Haridas HANDE, San Diego, CA (US); Chih-Ping LI, San Diego, CA (US); Peerapol TINNAKORNSRISUPHAP, San Diego, CA (US)

(21) Appl. No.: 18/772,934

(22) Filed: Jul. 15, 2024

(51) Int. Cl. H04W 72/40; H04W 72/51

(52) U.S. Cl. CPC H04W 72/40; H04W 72/51

(57) ABSTRACT

Various aspects of the present disclosure generally relate to wireless communication. In some aspects, a user equipment (UE) may transmit, to a network node, capability information associated with UE cooperation between the UE and a companion UE. The UE may receive, from the network node, a configuration of at least one of carrier aggregation (CA) or dual connectivity (DC) based at least in part on the capability information associated with the UE cooperation between the UE and the companion UE. Numerous other aspects are described.

### FIELD OF THE DISCLOSURE

Aspects of the present disclosure generally relate to wireless communication and specifically relate to techniques, apparatuses, and methods for dual connectivity and/or carrier aggregation for a user equipment with cooperation.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The UE may include one or more memories and one or more processors coupled to the one or more memories. The one or more processors may be configured to cause the UE to transmit, to a network node, capability information associated with UE cooperation between the UE and a companion UE. The one or more processors may be configured to cause the UE to receive, from the network node, a configuration of at least one of carrier aggregation (CA) or dual connectivity (DC) based at least in part on the capability information associated with the UE cooperation between the UE and the companion UE.

Some aspects described herein relate to a network node for wireless communication. The network node may include one or more memories and one or more processors coupled to the one or more memories. The one or more processors may be configured to cause the network node to receive, from a UE, capability information associated with UE cooperation between the UE and a companion UE. The one or more processors may be configured to cause the network node to transmit, to the UE, a configuration of at least one of CA or DC based at least in part on the capability information associated with the UE cooperation between the UE and the companion UE.

Some aspects described herein relate to a method of wireless communication performed by a UE. The method may include transmitting, to a network node, capability information associated with UE cooperation between the UE and a companion UE. The method may include receiving, from the network node, a configuration of at least one of CA or DC based at least in part on the capability information associated with the UE cooperation between the UE and the companion UE.

Some aspects described herein relate to a method of wireless communication performed by a network node. The method may include receiving, from UE, capability information associated with UE cooperation between the UE and a companion UE. The method may include transmitting, to the UE, a configuration of at least one of CA or DC based at least in part on the capability information associated with the UE cooperation between the UE and the companion UE.

Some aspects described herein relate to a non-transitory computer-readable medium that stores a set of instructions for wireless communication by a UE. The set of instructions, when executed by one or more processors of the UE, may cause the UE to transmit, to a network node, capability information associated with UE cooperation between the UE and a companion UE. The set of instructions, when executed by one or more processors of the UE, may cause the UE to receive, from the network node, a configuration of at least one of CA or DC based at least in part on the capability information associated with the UE cooperation between the UE and the companion UE.

Some aspects described herein relate to a non-transitory computer-readable medium that stores a set of instructions for wireless communication by a network node. The set of instructions, when executed by one or more processors of the network node, may cause the network node to receive, from a UE, capability information associated with UE cooperation between the UE and a companion UE. The set of instructions, when executed by one or more processors of the network node, may cause the network node to transmit, to the UE, a configuration of at least one of CA or DC based at least in part on the capability information associated with the UE cooperation between the UE and the companion UE.

Some aspects described herein relate to an apparatus for wireless communication. The apparatus may include means for transmitting, to a network node, capability information associated with cooperation between the apparatus and a companion UE. The apparatus may include means for receiving, from the network node, a configuration of at least one of CA or DC based at least in part on the capability information associated with the cooperation between the apparatus and the companion UE.

Some aspects described herein relate to an apparatus for wireless communication. The apparatus may include means for receiving, from UE, capability information associated with UE cooperation between the UE and a companion UE. The apparatus may include means for transmitting, to the UE, a configuration of at least one of CA or DC based at least in part on the capability information associated with the UE cooperation between the UE and the companion UE.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating examples of carrier aggregation (CA), in accordance with the present disclosure.

FIG. 5 is a diagram illustrating an example of dual connectivity (DC), in accordance with various aspects of the present disclosure.

FIG. 6 is a diagram illustrating an example of cooperation between an anchor UE and a companion UE, in accordance with the present disclosure.

FIGS. 7A-7C are diagrams illustrating examples of traffic forwarding from a companion UE to an anchor UE, in accordance with the present disclosure.

FIGS. 8A-8C are diagrams illustrating examples associated with CA for a UE with UE cooperation, in accordance with the present disclosure.

FIGS. 9A-9B are diagrams illustrating examples associated with DC for a UE with UE cooperation, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a network node or an apparatus of a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a user equipment (UE) may be configured for multi-carrier operations, such as carrier aggregation (CA) and/or dual connectivity (DC). CA is a multi-carrier operating mode that enables two or more component carriers (CCs) to be combined (e.g., into a single channel) for a UE to enhance data capacity. CCs can be combined in the same or different frequency bands. DC is a multi-carrier operating mode in which a UE may communicate with two network nodes in order to increase bandwidth and decrease traffic latency. One network node acts as a master node (MN) and the other network node acts as a secondary node (SN). In DC, the MN may communicate with the UE via a master cell group (MCG) that may include one or more serving cells (e.g., one or more CCs), and the SN may communicate with the UE via a secondary cell group (SCG) that may include one or more serving cells (e.g., one or more CCs).

A reduced capability (RedCap) UE may be a UE associated with a reduced number of antennas, bandwidth, power capacity, and/or transmission range, among other examples, as compared with a full capability UE. RedCap UEs may include, for example, wearable devices, extended reality (XR) devices (e.g., augmented reality (AR) glasses and/or virtual reality (VR) headsets, among other examples), Internet of Things (IoT) devices, industrial sensors, and/or cameras, among other examples. A wireless communications standard promulgated by the Third Generation Partnership Project (3GPP) currently requires a UE to support 4 receive (Rx) antennas with 100 MHz bandwidth (BW) in 5G frequency bands for full capability functionality. However, some UEs (e.g., RedCap UEs) may support fewer antennas and/or a smaller bandwidth. For example, an XR device, such as AR glasses, may be limited to 2 Rx antennas due to a form factor of the XR device. The 3GPP wireless communication standard supports reduced functionality for RedCap UEs with 2 Rx antennas and 20 MHz BW. However, 20 MHz BW may not be sufficient for traffic requirements associated with some RedCap UEs. For example, 20 MHz BW may not be sufficient to satisfy high data-rate immersive XR traffic requirements associated with an XR device. Currently, RedCap UEs are expected to operate in a single frequency band at a time, and CA and DC are not supported for RedCap UEs, which can limit traffic throughput for RedCap UEs.

Various aspects relate generally to enabling CA and/or DC for a UE (e.g., a RedCap UE) with UE cooperation. Some aspects more specifically relate to conditionally supporting CA and/or DC for a RedCap UE when the RedCap UE is operating in cooperation with a companion UE. In some aspects, a UE (e.g., a RedCap UE) may transmit, to a network node, capability information associated with UE cooperation between the UE and a companion UE. The UE may receive, from the network node, a configuration of CA or DC based at least in part on the capability information associated with UE cooperation between the UE and the companion UE. For example, CA or DC may be configured for the UE conditional on the capability information indicating UE cooperation where the companion UE supports processing the additional CC configured via the CA or DC configuration. In some examples, the capability information may indicate that the UE supports UE cooperation between the UE and the companion UE via transport block (TB) forwarding or packet data convergence protocol (PDCP) packets forwarding. In some other examples, the capability information may indicate that the UE supports UE cooperation between the UE and the companion UE via in-phase and quadrature (IQ) samples forwarding. In such examples, the capability information may indicate that a buffer capability of the UE is sufficient for storing IQ samples of multiple CCs, and/or the capability information may indicate a request for a relaxed baseband (BB) processing time.

Particular aspects of the subject matter described in this disclosure can be implemented to realize one or more of the following potential advantages. In some examples, by configuring CA and/or DC for the UE based at least in part on the capability information associated with the capability information associated with UE cooperation between the UE and the companion UE, the described techniques can be used to conditionally enable CA and/or DC for a RedCap UE when the RedCap UE is operating in cooperation with a companion UE that is available to process an additional CC for the RedCap UE. As a result, traffic throughput and data capacity for the RedCap UE may be increased.

In some examples, by indicating, in the capability information, that the UE supports UE cooperation between the UE and the companion UE via IQ samples forwarding, the described techniques can be used to enable CA and/or DC in which the companion UE forwards, to the UE, IQ samples received via the additional CC configured for the UE. Such CA and/or DC with IQ samples forwarding may result in a higher signal-to-noise ratio (SNR) as compared with TB or PDCP packets forwarding, and is not limited by the rank of connections of the UE and the companion UE with the network node. Furthermore, such CA and/or DC with IQ samples forwarding may provide gains in terms of additional signal-to-interference-plus-noise ratio (SINR) and rank, and increased fairness in allocating network resources, as compared with TB or PDCP packets forwarding. In some examples, by indicating that the buffer capability of the UE is sufficient for storing IQ samples of multiple CCs, the described techniques can be used to enable CA and/or DC with IQ samples forwarding when the UE has a sufficient buffer size to handle processing of a larger physical downlink shared channel (PDSCH) BW resulting from the IQ samples forwarding. In some examples, by indicating a request for a relaxed BB processing time, the described techniques may be used to enable the UE to process the larger PDSCH BW resulting from the IQ samples forwarding at a relaxed BB processing timeline.

In some examples, by indicating, in the capability information, that the UE supports UE cooperation between the UE and the companion UE via TB forwarding or PDCP packets forwarding, the described techniques can be used to enable CA and/or DC in which the companion UE forwards, to the UE, TBs or PDCP packets received via the additional CC configured for the UE. As a result, CA and/or DC may be enabled for the UE with a smaller buffer size, as compared with CA and/or DC with IQ samples forwarding, and without a relaxed BB processing timeline. Furthermore, such CA and/or DC with TB forwarding or PDCP packets forwarding may result in additional network resources allocated to traffic for the UE, resulting in increased traffic throughput, as compared with CA and/or DC with IQ samples forwarding.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the 3GPP. 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, IoT connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks RedCap UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

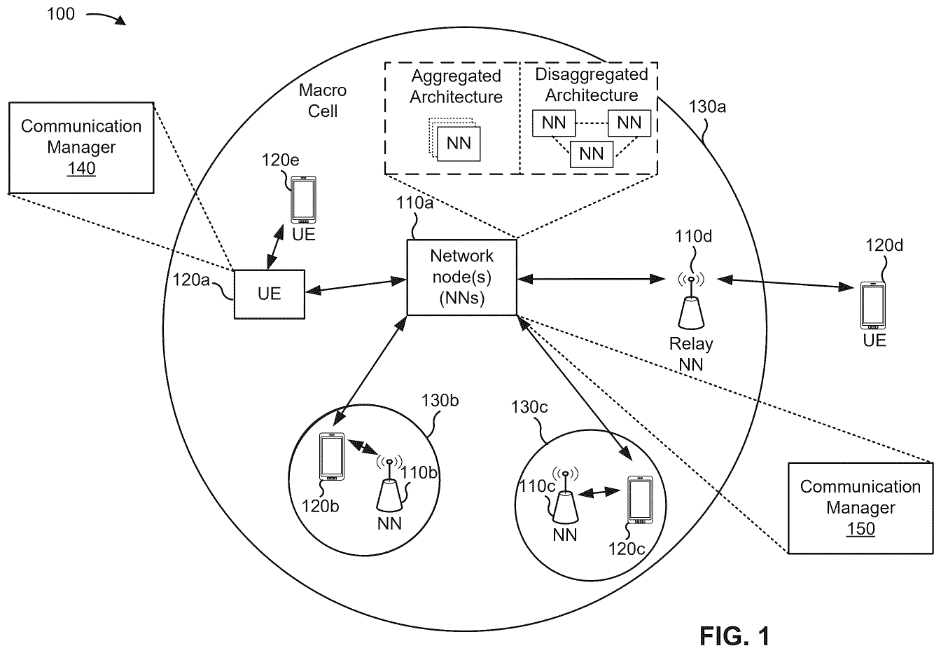

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, PDCP functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more PDSCHs. Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, XR devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, smart city deployments, and/or XR applications, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may transmit, to a network node, capability information associated with UE cooperation between the UE 120 and a companion UE; and receive, from the network node, a configuration of at least one of CA or DC based at least in part on the capability information associated with the UE cooperation between the UE 120 and the companion UE. Additionally, or alternatively, the communication manager 140 may perform one or more other operations described herein.

In some aspects, the network node 110 may include a communication manager 150. As described in more detail elsewhere herein, the communication manager 150 may receive, from a UE, capability information associated with UE cooperation between the UE and a companion UE; and transmit, to the UE, a configuration of at least one of CA or DC based at least in part on the capability information associated with the UE cooperation between the UE and the companion UE. Additionally, or alternatively, the communication manager 150 may perform one or more other operations described herein.

As indicated above, FIG. 1 is provided as an example. Other examples may differ from what is described with regard to FIG. 1.

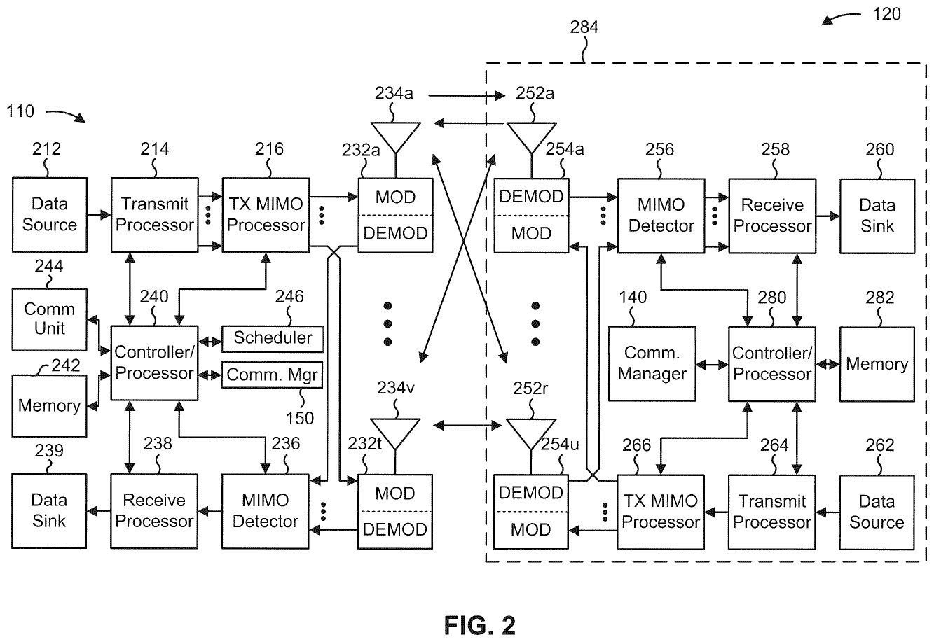

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more TBs of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (RX) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

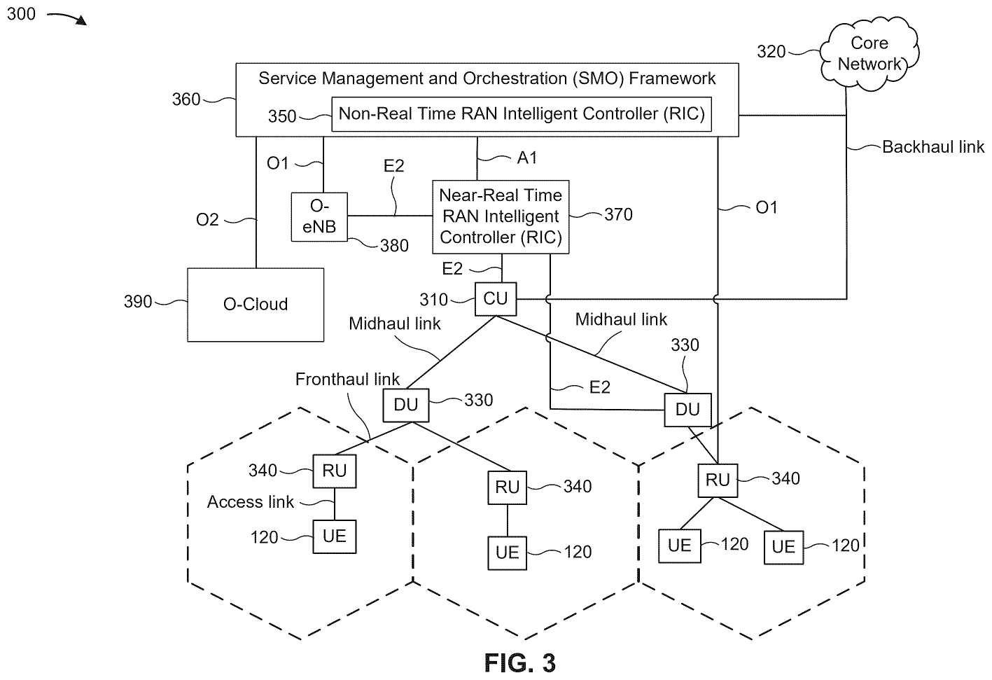

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

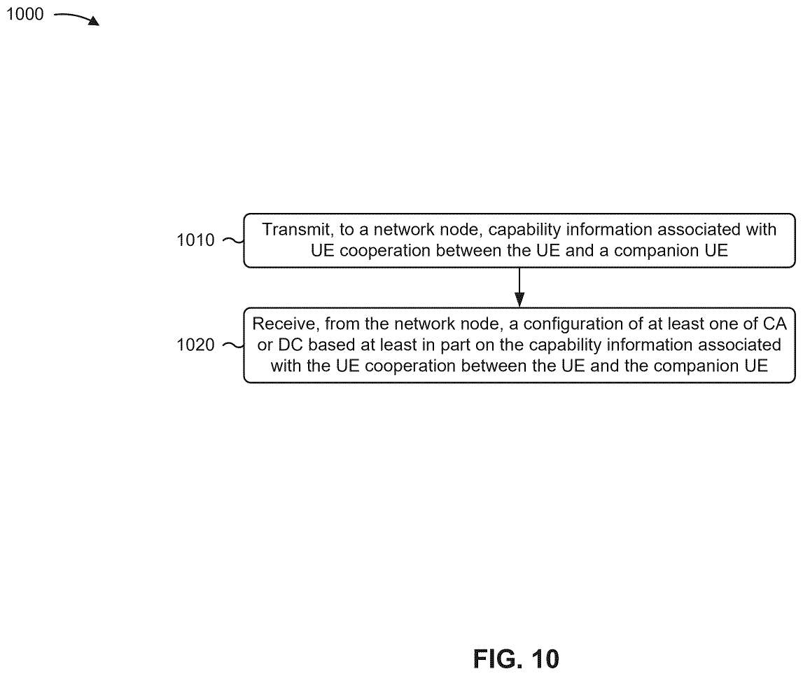

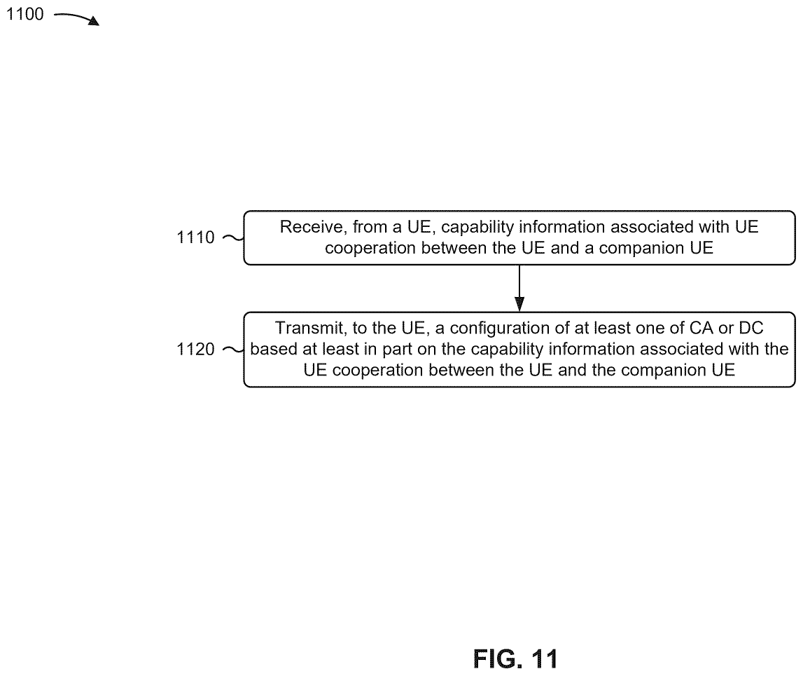

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with for DC and/or CA for a UE with cooperation, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, a UE (e.g., the UE 120) includes means for transmitting, to a network node, capability information associated with UE cooperation between the UE and a companion UE; and/or means for receiving, from the network node, a configuration of at least one of CA or DC based at least in part on the capability information associated with the UE cooperation between the UE and the companion UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, from a UE, capability information associated with UE cooperation between the UE and a companion UE; and/or means for transmitting, to the UE, a configuration of at least one of CA or DC based at least in part on the capability information associated with the UE cooperation between the UE and the companion UE. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

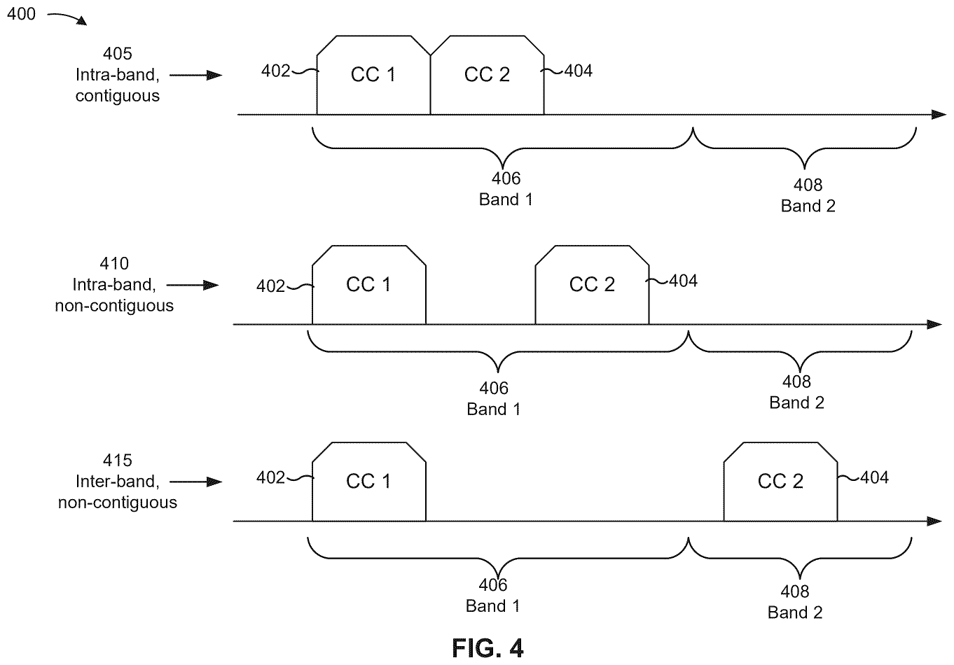

FIG. 4 is a diagram illustrating examples 400 of CA, in accordance with the present disclosure.

CA is a technology that enables two or more CCs (sometimes referred to as “carriers”) to be combined (e.g., into a single channel) for a single UE 120 to enhance data capacity. As shown, carriers (shown as a first carrier (CC 1) 402 and a second carrier (CC 2) 404) can be combined in the same or different frequency bands (shown as a first band (Band 1) 406 and a second band (Band 2) 408). Additionally, or alternatively, contiguous or non-contiguous carriers can be combined. A network node 110 may configure carrier aggregation for a UE 120, such as in an RRC message, DCI, and/or another signaling message.

As shown by reference number 405, in some aspects, carrier aggregation may be configured in an intra-band contiguous mode where the aggregated carriers (e.g., CC 1 402 and CC 2 404) are contiguous to one another and are in the same band (e.g., Band 1 406). As shown by reference number 410, in some aspects, carrier aggregation may be configured in an intra-band non-contiguous mode where the aggregated carriers (e.g., CC 1 402 and CC 2 404) are non-contiguous to one another and are in the same band (e.g., Band 1 406). As shown by reference number 415, in some aspects, carrier aggregation may be configured in an inter-band non-contiguous mode where the aggregated carriers (e.g., CC 1 402 and CC 2 404) are non-contiguous to one another and are in different bands (e.g., Band 1 406 and Band 2 408).

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As indicated above, FIG. 4 is provided as an example. Other examples may differ from what is described with regard to FIG. 4.

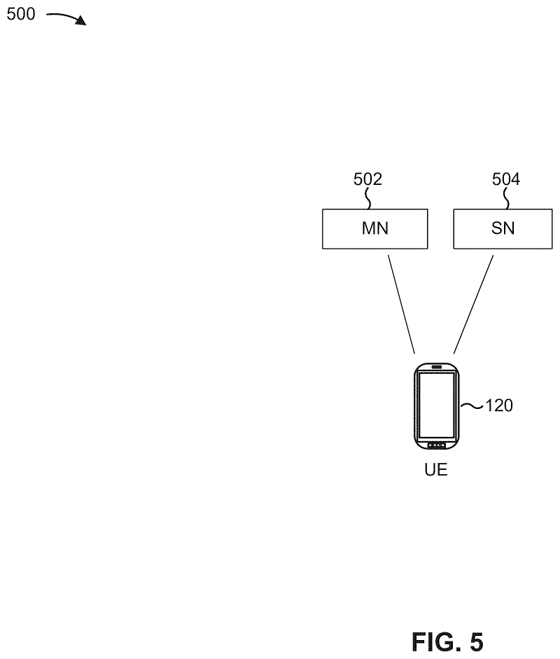

FIG. 5 is a diagram illustrating an example 500 of DC, in accordance with various aspects of the present disclosure.

As shown in FIG. 5, in NR, DC is a feature in which a UE 120 may communicate with two network nodes in order to increase bandwidth and decrease traffic latency. One network node acts as an MN 502 and the other network node acts as an SN 504. The MN 502 may be an eNB (e.g., a 4G network node, LTE network node, or the like), a gNB DU (e.g., a 5G network node, NR network node, or the like), or a 6G network node, among other examples. The SN 504 may be a gNB DU (e.g., a 5G network node, NR network node, or the like) or a 6G network node, among other examples. The MN 502 and the SN 504 may communicate (e.g., directly or indirectly) with a 4G/LTE core network, a 5G/NR core network (e.g., via a gNB CU), and/or a 6G core network, among other examples.

In some cases, DC may be used together with CA. When CA is used, there may be a number of serving cells (e.g., one for each carrier). The coverage of the serving cells may differ, for example due to different carriers on different frequency bands experiencing different pathloss.

In DC, the MN 502 may communicate with the UE 120 via an MCG. The MCG may include multiple serving cells (e.g., a Pcell and one or more Scells) when CA is activated. The MCG may include a single serving cell when CA is not activated. The SN 504 may communicate with the UE 120 via an SCG. The SCG may include multiple serving cells (e.g., a primary secondary cell (PScell) and one or more Scells) when CA is activated. The SCG may include a single serving cell when CA is not activated.

As indicated above, FIG. 5 is provided as an example. Other examples may differ from what is described with regard to FIG. 5.

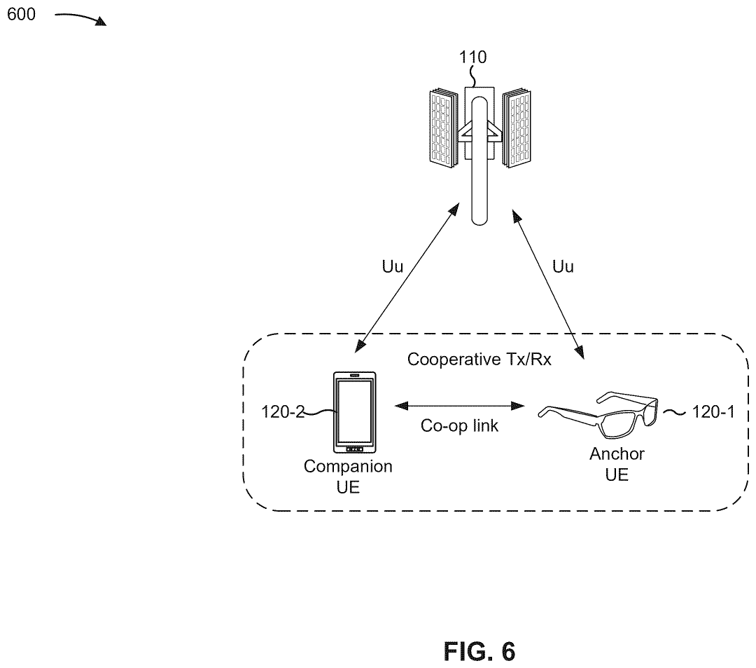

FIG. 6 is a diagram illustrating an example 600 of cooperation between an anchor and a companion UE, in accordance with the present disclosure.

Example 600 includes a network node 110, an anchor UE 120-1, and a companion UE 120-2. As shown in FIG. 6, the anchor UE 120-1 and the companion UE 120-2 may each communicate with the network node 110 via a Uu interface (e.g., via Uu links), and the anchor UE 120-1 and the companion UE 120-2 may perform cooperative communications (e.g., cooperative transmission and reception) via a co-op link. In some examples, the co-op link may be a wireless communication link (e.g., a sidelink). For example, the anchor UE 120-1 and the companion UE 120-2 may communicate via NR sidelink (e.g., via a PC5 interface or PC5 link), ultra-wideband (UWB), Wi-Fi, or a wireless personal area network (WPAN) (e.g., Bluetooth or the like), among other examples. In some other examples, the co-op link may be a wired link (e.g., a wired tether or connection), such as a universal serial bus (USB) connection, between the anchor UE 120-1 and the companion UE 120-2.

The anchor UE 120-1 may be a UE for which downlink traffic from the network node 110 is targeted and/or a UE at which uplink traffic originates. The companion UE 120-2 (also referred to as a helper UE) may be a UE that assists the anchor UE 120-1 by receiving downlink traffic destined for the anchor UE 120-1 from the network node 110 and forwarding the downlink traffic to the anchor UE 120-1, and/or by forwarding uplink traffic from the anchor UE 120-1 to the network node 110. In some examples, the anchor UE 120-1 may be a RedCap UE. For example, the anchor UE 120-1 may be a XR device (e.g., a pair of AR glasses (as shown in example 600) or a VR headset) or a wearable device (e.g., a smart watch or another type of wearable device), among other examples. In other examples, the anchor UE 120-1 may be any other type of UE. In some examples, the companion UE 120-2 may be a cellular phone (e.g., a smart phone), a laptop computer, a vehicular UE, or any other type of UE.

In some examples, the anchor UE 120-1 and the companion UE 120-2 may cooperate to increase a spatial multiplexing capability of the anchor UE 120-1, which may translate to significant gains in user-perceived throughput (e.g., at the anchor UE 120-1) as well as system throughput (e.g., network throughput). Additionally, or alternatively, the anchor UE 120-1 and the companion UE 120-2 may cooperate for load balancing. In some examples, the anchor UE 120-1 and the companion UE 120-2 (e.g., and/or one or more other companion UEs associated with the anchor UE 120-1) may be aggregated into a virtual UE to maximize MIMO gains or for load balancing. For example, the network node 110 may consider the anchor UE 120-1 and the companion UE 120-2 as one UE (e.g., the virtual UE). The aggregation of the anchor UE 120-1 and the companion UE 120-2 into the virtual UE may be based at least in part on an assumption of the existence of a low power, high BW, low latency, high reliability co-op link between the companion UE 120-2 and the anchor UE 120-1. For example, the anchor UE 120-1 may be an XR device (e.g., AR glasses) or a wearable device with 2 Rx antennas or 1 Rx antenna, and through UE cooperation, the anchor UE 120-1 and the companion UE 120-2 can be aggregated into a virtual device with 4 or more Rx antennas.

In some examples, each of the anchor UE 120-1 and the companion UE 120-2 may include one or more cellular antennas, a full Uu protocol stack for communicating via the Uu interface, and a sidelink modem for communicating via the co-op link. In some examples, the companion UE 120-2 may be or act as an external antenna panel for the anchor UE 120-1. In such examples, the companion UE 120-2 may flexibly forward data at lower layers to the anchor UE 120-1. For example, the companion UE 120-2 may act as an external antenna panel by data at the IQ samples level to the anchor UE 120-1. In some other examples, the companion UE 120-2 may be or act as a companion device cooperating at the MAC level. In such examples, the companion UE 120-2 may forward data at the TB level to the anchor UE 120-1. In some other example, the companion UE 120-2 may be or act as a layer 3 (L3) multiple path (multi-path) relay. In such examples, the companion UE 120-2 may forward data at the L3 level (or above) to the anchor UE 120-1. For example, the companion UE 120-2 may act as the L3 multi-path relay by forwarding data at the PDCP level to the anchor UE 120-1.

As indicated above, FIG. 6 is provided as an example. Other examples may differ from what is described with respect to FIG. 6.

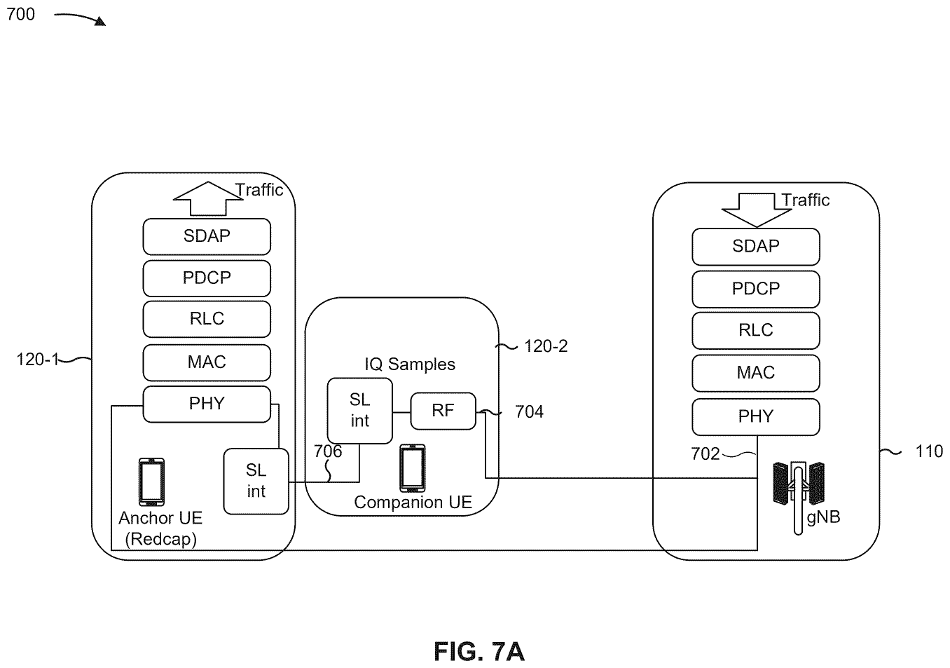

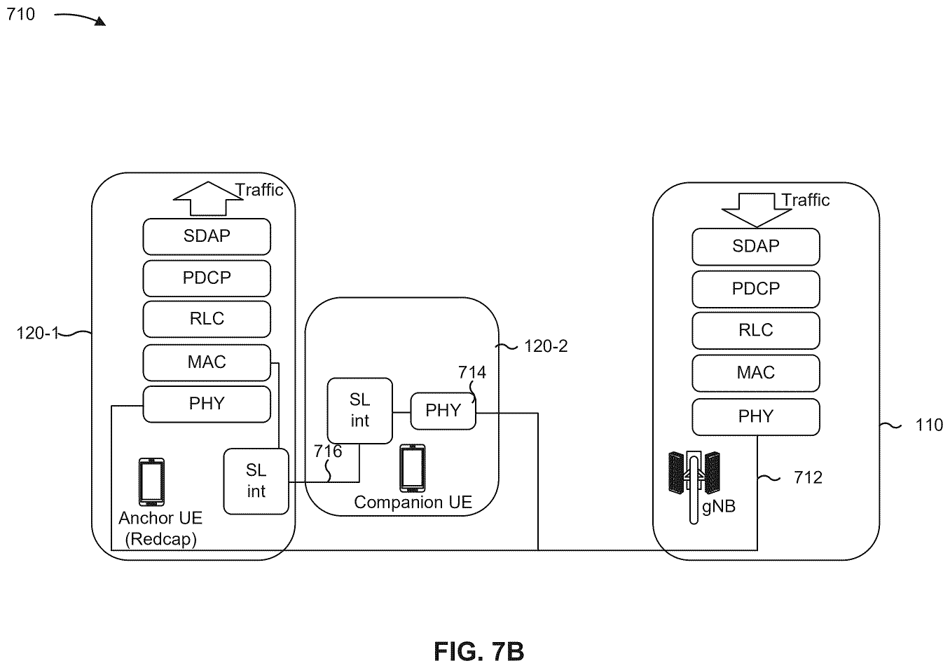

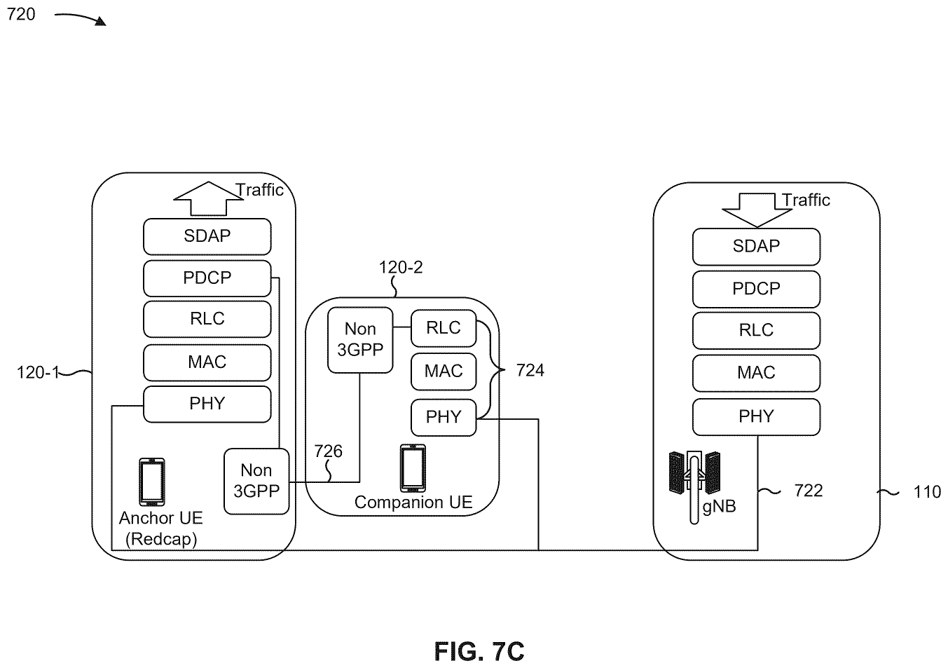

FIGS. 7A-7C are diagrams illustrating examples of traffic forwarding from a companion UE to an anchor UE, in accordance with the present disclosure.

As shown in FIGS. 7A-7C, during UE cooperation between an anchor UE 120-1 and a companion UE 120-2, processing of data in in a traffic flow (e.g., a quality of service (QOS) flow or a service data flow (SDF)) at lower layers of a protocol stack may be split between the anchor UE 120-1 and the companion UE 120-2. In some cases, the companion UE 120-2 may implement one or more lower layers of the protocol stack. Which lower layers are implemented by the companion UE 120-2 may be up to UE implementation and/or sidelink properties (e.g., properties of the co-op link between the anchor UE 120-1 and the companion UE 120-2). The anchor UE 120-1 may implement the full protocol stack (e.g., including PHY, MAC, RLC, PDCP, and SDAP layers), and data processing at higher layers may be performed at the anchor UE 120-1. The traffic/data forwarding by the companion UE 120-2 shown in FIGS. 7A-7C enables one QoS flow or SDF to be mapped (e.g., by the network node 110) to the two connections (e.g., to the anchor UE 120-1 and the companion UE 120-2).

FIG. 7A shows an example 700 of UE cooperation via IQ samples forwarding. In example 700, the companion UE 120-2 acts as an external antenna panel device (e.g., for the anchor UE 120-1) and forwards data at the IQ sampling level to the anchor UE 120-1. As shown in FIG. 7A, and by reference number 702, the network node 110 (e.g., the PHY layer of the network node 110) transmits data (e.g., IQ samples) of a traffic flow (e.g., a QoS flow or an SDF) to the anchor UE 120-1 and the companion UE 120-2. In example 700, the companion UE 120-2 acting as the external antenna panel device enables one traffic flow to be mapped to the two connections (e.g., to the anchor UE 120-1 and the companion UE 120-2). As shown by reference number 704, the companion UE 120-2 may receive, via RF circuitry (e.g., a transceiver and/or other components of an RF chain), the data transmitted from the network node 110 to the companion UE 120-2. As shown by reference number 706, the companion UE 120-2 may forward, to the anchor UE 120-1 via a sidelink interface, the data (e.g., the IQ samples) received from the network node 110. For example, the sidelink interface may be a non-3GPP interface (e.g., UWB, Wi-Fi, or Bluetooth, among other examples) or NR sidelink (e.g., PC5) interface, among other examples. In example 700, the companion UE 120-2 may act as a IQ sample repeater. That is, the companion UE 120-2 may forward (or repeat), to the anchor UE 120-1, the data (e.g., IQ samples) received from the network node 110 without performing decoding or other PHY layer processing of the data. In example 700, the anchor UE 120-1 may receive the data (e.g., IQ samples) transmitted to the anchor UE 120-1 from the network node 110 and receive (e.g., via the sidelink interface) the data (e.g., IQ samples) forwarded to the anchor UE 120-1 by the companion UE 120-2, and the anchor UE 120-1 may perform the PHY layer processing for the data received from the network node 110 and the data received from the companion UE 120-2. For example, the anchor UE 120-1 may perform BB processing for the IQ samples received from the network node 110 and the IQ samples forwarded to the anchor UE 120-1 from the companion UE 120-2. The anchor UE 120-1 may then perform MAC layer processing, RLC layer processing, PDCP layer processing, and SDAP layer processing for the data.

FIG. 7B shows an example 710 of UE cooperation via TB forwarding (e.g., MAC level forwarding). In example 710, the companion UE 120-2 acts as a companion device cooperating at MAC and forwards data at the MAC level to the anchor UE 120-1. As shown in FIG. 7B, and by reference number 712, the network node 110 (e.g., the PHY layer of the network node 110) transmits data of a traffic flow (e.g., a QoS flow or an SDF) to the anchor UE 120-1 and the companion UE 120-2. As shown by reference number 714, the companion UE 120-2 may perform PHY layer processing (e.g., PHY layer decoding and/or BB processing) for the data received at the companion UE 120-2 from the network node 110. As shown by reference number 716, the companion UE 120-2 may forward, to the anchor UE 120-1 via the sidelink interface, MAC level data (e.g., one or more TBs) resulting from the PHY layer processing. The anchor UE 120-1 may receive the data transmitted to the anchor UE 120-1 from the network node 110 and receive (e.g., via the sidelink interface) the MAC level data (e.g., one or more TBs) forwarded to the anchor UE 120-1 by the companion UE 120-2. The anchor UE 120-1 may perform PHY layer processing for the data received from the network node 110, and the anchor UE 120-1 may perform MAC layer processing for the MAC level data (e.g., one or more TBs) forwarded by the companion UE 120-2 as well as the data received from the network node 110 (e.g., after performing the PHY layer processing). The anchor UE 120-1 may then perform RLC layer processing, PDCP layer processing, and SDAP layer processing for the data.

FIG. 7C shows an example 720 of UE cooperation via PDCP packets forwarding (e.g., PDCP level forwarding). In example 720, the companion UE 120-2 acts as an L3 multi-path relay (e.g., a companion device cooperating at PDCP) and forwards data at the PDCP level to the anchor UE 120-1. As shown in FIG. 7C, and by reference number 722, the network node 110 (e.g., the PHY layer of the network node 110) transmits data of a traffic flow (e.g., a QoS flow or an SDF) to the anchor UE 120-1 and the companion UE 120-2. As shown by reference number 724, the companion UE 120-2 may perform PHY layer processing, MAC layer processing, and RLC layer processing for the data received at the companion UE 120-2 from the network node 110. As shown by reference number 726, the companion UE 120-2 may forward, to the anchor UE 120-1 via the sidelink interface, PDCP level data (e.g., PDCP packets) resulting from the PHY layer processing, MAC layer processing, and RLC layer processing performed by the companion UE 120-2. The anchor UE 120-1 may receive the data transmitted to the anchor UE 120-1 from the network node 110 and receive (e.g., via the sidelink interface) the PDCP level data (e.g., PDCP packets) forwarded to the anchor UE 120-1 by the companion UE 120-2. The anchor UE 120-1 may perform PHY layer processing, MAC layer processing, and RLC layer processing for the data received from the network node 110, and the anchor UE 120-1 may perform PDCP layer processing for the PDCP level data (e.g., PDCP packets) forwarded by the companion UE 120-2 as well as the data received from the network node 110 (e.g., after performing the PHY layer processing, MAC layer processing, and RLC layer processing). The anchor UE 120-1 may then perform SDAP layer processing for the data.

As indicated above, FIG. 7 is provided as an example. Other examples may differ from what is described with respect to FIG. 7.

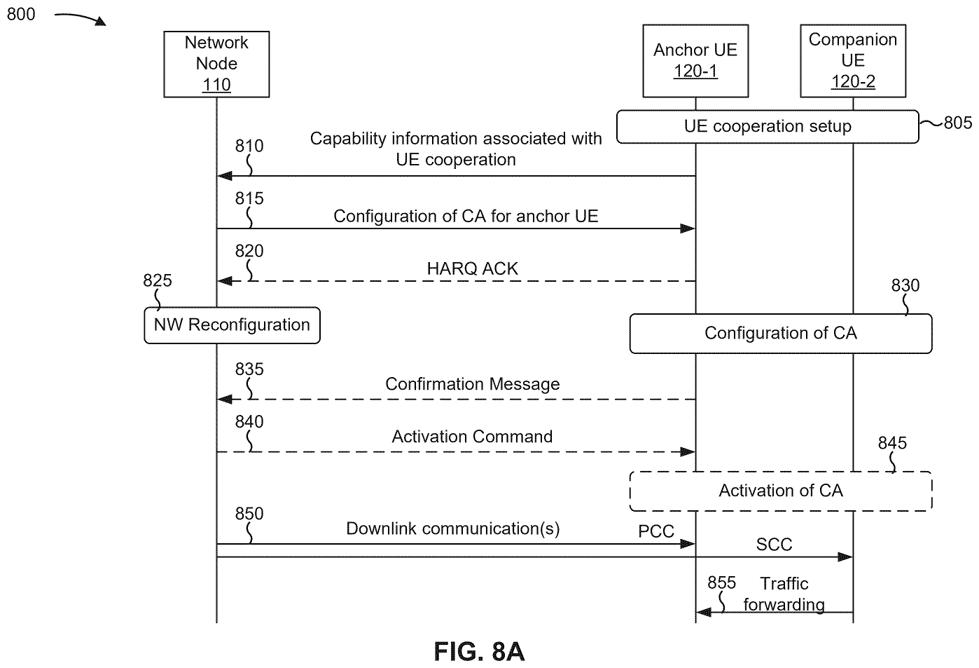

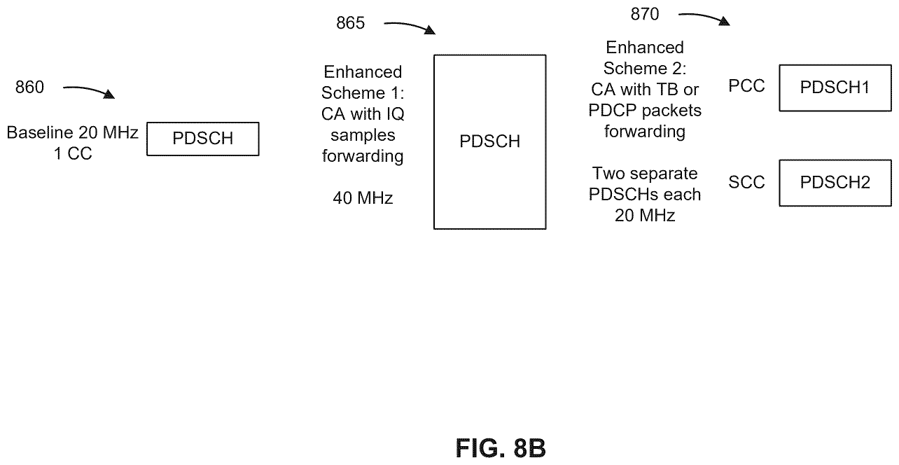

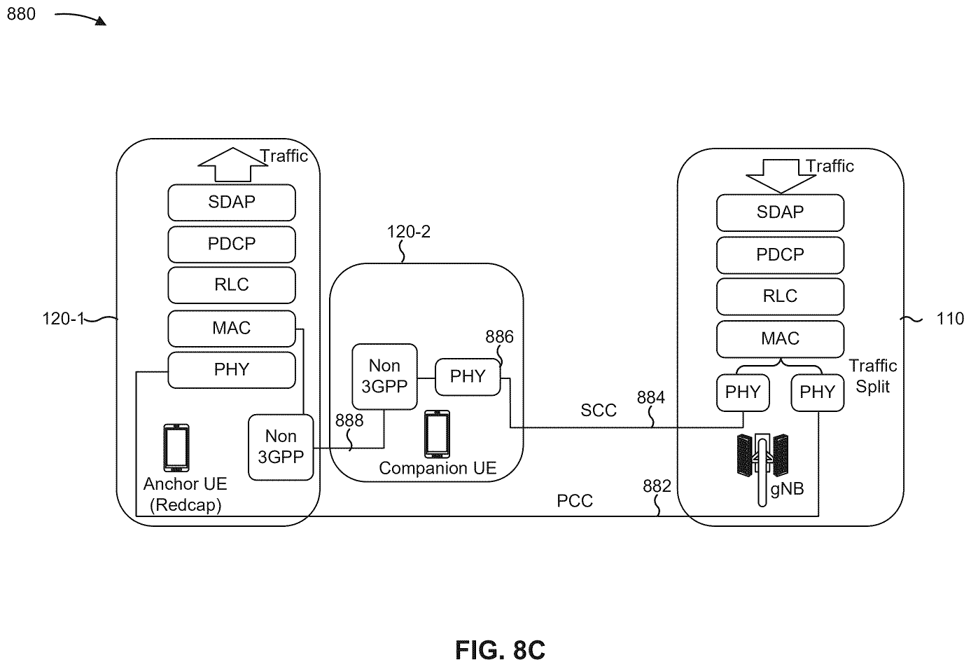

FIGS. 8A-8C are diagrams illustrating examples associated with CA for a UE with UE cooperation, in accordance with the present disclosure. As shown in FIG. 8A, example 800 includes a network node 110, an anchor UE 120-1, and a companion UE 120-2. In some aspects, the network node 110, the anchor UE 120-1, and the companion UE 120-2 may be included in a wireless communication network, such as wireless communication network 100. In some aspects, the anchor UE 120-1 may be a RedCap UE. For example, the anchor UE 120-1 may be an XR device (e.g., AR glasses or a VR headset) or a wearable device (e.g., a smartwatch or another type of wearable device), among other examples.

In some aspects, the anchor UE 120-1 and the companion UE 120-2 may communicate via sidelink communications over a sidelink interface. In some aspects, sidelink communications described in connection with FIGS. 8A-8C may be NR sidelink communications over an NR sidelink interface (e.g., a PC5 interface). In some aspects, the sidelink communications described in connection with FIGS. 8A-8C may be wireless communications over another type of sidelink interface (e.g., a non-3GPP sidelink interface), such as UWB, Wi-Fi, or a PAN (e.g., Bluetooth or the like), among other examples. In some aspects, the sidelink communications described in connection with FIGS. 8A-8C may be communications over a wired connection, such as a USB connection or the like.

As shown in FIG. 8A, and by reference number 805, the anchor UE 120-1 and the companion UE 120-2 may set up UE cooperation between the anchor UE 120-1 and the companion UE 120-2. The anchor UE 120-1 and the companion UE 120-2 may communicate with each other via one or more sidelink communications to establish (or set up) the UE cooperation between the anchor UE 120-1 and the companion UE 120-2. In some aspects, the anchor UE 120-1 and the companion UE 120-2 may perform a pairing procedure to establish the UE cooperation between the anchor UE 120-1 and the companion UE 120-2.

In some aspects, the anchor UE 120-1 and the companion UE 120-2 may communicate to determine a type of UE cooperation supported by the anchor UE 120-1 and the companion UE 120-2. For example, the companion UE 120-2 may transmit (via the sidelink interface), and the anchor UE 120-1 may receive, an indication of a type of UE cooperation supported by the companion UE 120-2 (or multiple types of UE cooperation supported by the companion UE 120-2). The type of UE cooperation may correspond to a type of traffic forwarding to be performed by the companion UE 120-2. For example, the companion UE 120-2 may indicate, to the anchor UE 120-1, whether the companion UE 120-2 supports UE cooperation via IQ samples forwarding, TB forwarding, and/or PDCP forwarding. In some aspects, the companion UE 120-2 may transmit, and the anchor UE 120-1 may receive, an indication of a UE identifier of the companion UE 120-2.

As further shown in FIG. 8A, and by reference number 810, the anchor UE 120-1 may transmit, and the network node 110 may receive, capability information associated with the UE cooperation between the anchor UE 120-1 and the companion UE 120-2. In some aspects, the capability information associated with the UE cooperation may be included in an anchor UE report (or multiple anchor UE reports) transmitted from the anchor UE 120-1 to the network node 110. For example, the anchor UE 120-1 may transmit, and the network node 110 may receive, a semi-static report (or message) (e.g., via RRC signaling) that includes some or all of the capability information associated with the UE cooperation. Additionally, or alternatively, the UE may transmit, and the network node 110 may receive, a dynamic report (e.g., via a MAC-CE) that includes some or all of the capability information associated with the UE cooperation. In some aspects, the capability information associated with the UE cooperation may be included in any type of report or message transmitted from the anchor UE 120-1 to the network node 110. For example, the capability information may be included in a semi-static UE capability report, a dynamic UE capability report, UE assistance information, or a MAC-CE, among other examples.

In some aspects, the capability information may indicate a RedCap UE capability. That is, the capability information may indicate that the anchor UE 120-1 is a RedCap UE. In some aspects, the capability information indicates a UE cooperation capability (or UE cooperation ability). For example, the UE cooperation capability may include an indication that the anchor UE 120-1 supports UE cooperation (e.g., with the companion UE 120-2) and/or an indication of a type (or types) of UE cooperation (e.g., UE cooperation via IQ samples forwarding, TB forwarding, or PDCP packets forwarding) supported by the anchor UE 120-1. In some aspects, the capability information may indicate the UE identifier of the companion UE 120-2. In some aspects, the capability information may indicate a request for CA approval.

In some aspects, the capability information may indicate the UE cooperation capability (e.g., an indication that the anchor UE 120-1 supports UE cooperation and/or an indication of a type of UE cooperation supported by the anchor UE 120-1) and an availability of the companion UE 120-2 (e.g., an availability of the companion UE 120-2 to process additional transmissions for the anchor UE 120-1 on an additional CC). The availability of the companion UE 120-2 may be based on or otherwise associated with sidelink conditions between the anchor UE 120-1 and the companion UE 120-2. In some aspects, the capability information may indicate one or more sidelink conditions (e.g., one or more sidelink channel measurements) between the anchor UE 120-1 and the companion UE 120-2. In some examples, the anchor UE 120-1 may periodically report sidelink channel measurements to the network node 110. In some other examples, the anchor UE 120-1 may indicate the sidelink channel measurements to the network node 110 via aperiodic reporting. For example, the aperiodic reporting may be based at least in part on the anchor UE 120-1 detecting a change in the sidelink conditions (e.g., a change in the sidelink conditions indicative of a problem with the sidelink conditions, or a change in the sidelink conditions indicative of an improvement or resolution of a problem with the sidelink conditions).

In some aspects, the capability information may indicate that the anchor UE 120-1 supports UE cooperation between the anchor UE 120-1 and the companion UE 120-2 via TB forwarding or PDCP packets forwarding. In some aspects, the capability information may indicate that the anchor UE 120-1 supports UE cooperation between the anchor UE 120-1 and the companion UE 120-2 via IQ samples forwarding. In some examples, in a case in which the capability information indicates that the anchor UE 120-1 supports UE cooperation via IQ samples forwarding, the capability information may also indicate a buffer capability of the anchor UE 120-1. For example, the buffer capability may indicate whether the anchor UE 120-1 has a sufficient time domain (TD) or frequency domain (FD) buffer size to handle processing of a larger PDSCH BW, as compared with a reduced BW associated with the anchor UE 120-1.

In a case in which the anchor UE 120-1 is a RedCap UE, a secondary CC (SCC) is activated for the anchor UE 120-1 (e.g., in addition to a primary CC (PCC)), and the companion UE 120-2 forwards IQ samples of a PDSCH transmitted on the SCC, the anchor UE 120-1 may process the forwarded IQ samples at a relaxed BB processing timeline. However, the anchor UE 120-1 (e.g., a RedCap UE) may not have enough buffer to store the IQ samples forwarded to the anchor UE 120-1 by the anchor UE 120-1 as well as IQ samples received from the network node 110 over the PCC. In some aspects, in a case in which the capability information indicates that the anchor UE 120-1 supports UE cooperation via IQ samples forwarding, the capability information may indicate whether the anchor UE 120-1 has a large enough buffer size to store IQ samples of multiple CCs. For example, the capability information may indicate that the buffer capability of the anchor UE 120-1 is sufficient for storing IQ samples of multiple CCs. Additionally, or alternatively, in a case in which the capability information indicates that the anchor UE 120-1 supports UE cooperation via IQ samples forwarding, the capability information may indicate a request for a relaxed BB processing time.

FIG. 8B shows an example 860 of a baseline PDSCH BW for the anchor UE 120-1 in a case in which the anchor UE 120-1 is a RedCap UE. As shown in example 860, the anchor UE 120-1 may have a baseline PDSCH BW of 20 MHz for receiving a PDSCH on 1 CC (e.g., without CA activated for the anchor UE 120-1).

FIG. 8B further shows an example 865 of a first enhanced scheme in which CA is activated (e.g., a PCC and an SCC are activated) for the anchor UE 120-1, and the UE cooperation between the anchor UE 120-1 and the companion UE 120-2 uses IQ samples forwarding. In example 865, the anchor UE 120-1 may be considered (e.g., by the network node 110) as a 40 MHz RF and 20 MHz BB UE. In this case, the anchor UE 120-1 may receive IQ samples of 20 MHz of PDSCH on the PCC, and the companion UE 120-2 includes RF operations, such that the companion UE 120-2 may perform RF processing and forward IQ samples of an additional 20 MHz of PDSCH of the same TB or a different TB. In example 865, the anchor UE 120-1 may process the larger (e.g., 40 MHz) PDSCH at a relaxed processing capability (e.g., in accordance with a relaxed BB processing timeline). In this example, the anchor UE 120-1 may indicate (e.g., in the capability information), that the anchor UE 120-1 has a large enough buffer size to store the IQ samples of the 40 MHz of PDSCH while the BB processing is being performed at a lower frequency (e.g., in accordance with the relaxed BB processing timeline). The anchor UE 120-1 may also indicate (e.g., in the capability information) a request for a relaxed BB processing time. In this example, the anchor UE 120-1 may perform all RF and BB processing operations, including Rx FFT, demapping, and decoding.

FIG. 8B further shows an example 870 of a second enhance scheme is which CA is activated (e.g., a PCC and an SCC are activated) for the anchor UE 120-1, the UE cooperation between the anchor UE 120-1 and the companion UE 120-2 uses TB or PDCP packets forwarding. In example 870, two separate 20 MHz PDSCHs may be frequency-division-multiplexed (FDMed) on the PCC and the SCC (e.g., PDSCH1 on the PCC and PDSCH2 on the SCC). The anchor UE 120-1 may receive PDSCH1 on the PCC and the companion UE 120-2 may receive PDSCH2 on the SCC. In this example, the companion UE 120-2 may forward decoded TBs (e.g., TB samples) at the MAC level or PDCP packets at the PDCP level of PDSCH2 received on the SCC, and there may be no need for relaxation of the BB processing timeline for the anchor UE 120-1. Accordingly, in an example in which the UE cooperation between the anchor UE 120-1 and the companion UE 120-2 uses TB forwarding or PDCP packets forwarding, the capability information may not indicate a request for a relaxed BB processing time and/or a buffer capability of the anchor UE 120-1.

Returning to FIG. 8A, as shown by reference number 815, the network node 110 may transmit, and the anchor UE 120-1 may receive, a configuration of CA (or CA configuration) for the anchor UE 120-1 based at least in part on the capability information associated with the UE cooperation between the anchor UE 120-1 and the companion UE 120-2. In some aspects, the configuration of CA for the anchor UE 120-1 may be transmitted to the anchor UE 120-1 via RRC signaling. For example, the configuration of CA for the anchor UE 120-1 may be included in an RRC connection reconfiguration message that is transmitted by the network node 110 and received by the anchor UE 120-1. In some examples, the RRC connection reconfiguration message may be a message approving CA for the anchor UE 120-1. For example, the network node 110 may transmit the RRC connection reconfiguration message approving CA for the anchor UE 120-1 during an RRC connection establishment procedure.

The CA configuration may indicate a configuration of a first carrier (e.g., a PCC) and a second carrier (e.g., an SCC) for the anchor UE 120-1. In some aspects, the network node 110 may determine whether to approve/configure CA for the anchor UE 120-1 based at least in part on the capability information associated with the UE cooperation between the anchor UE 120-1 and the companion UE 120-2, and the network node 110 may transmit the configuration of the CA for the anchor UE 120-1 in connection with a determination to approve/configure CA for the anchor UE 120-1. Without UE cooperation, the baseline scheme may be one CC (e.g., no CA) for a RedCap UE. In some aspects, the network node 110 may approve/configure CA for a RedCap UE (e.g., the anchor UE 120-1) in connection with receiving the capability information associated with UE cooperation between the RedCap UE (e.g., the anchor UE 120-1) and a companion UE (e.g., the companion UE 120-2). That is, enabling CA for the anchor UE 120-1 (e.g., a RedCap UE) may be conditional on the UE cooperation between the anchor UE 120-1 and the companion UE 120-2. For example, in connection with the capability information indicating support for UE cooperation between the anchor UE 120-1 and the companion UE 120-2, the network node 110 may determine to approve/configure CA for the anchor UE 120-1. Accordingly, with UE cooperation between the anchor UE 120-1 and the companion UE 120-2, the anchor UE 120-1 may be configured (an activated) with two carriers (e.g., the PCC and the SCC).

In some aspects, in a case in which the capability information indicates that the anchor UE 120-1 supports UE cooperation between the anchor UE 120-1 and the companion UE 120-2 via IQ samples forwarding, the determination of whether to approve/configure CA for the anchor UE 120-1 may be based at least in part on the indication, in the capability information, of the buffer capability or the anchor UE 120-1. In such examples, the network node 110 may approve/configure CA for the anchor UE 120-1 in connection with the capability information indicating that the buffer capability of the anchor UE 120-1 is sufficient for storing IQ samples of multiple component carriers. In some aspects, in a case in which the capability information indicates that the anchor UE 120-1 supports UE cooperation between the anchor UE 120-1 and the companion UE 120-2 via IQ samples forwarding, the network node 110 may configure a relaxed BB processing timeline for the anchor UE 120-1. In such examples, the CA configuration may indicate a relaxed value for a BB processing time parameter N1.

In some aspects, the network node 110 may configure/approve CA (e.g., multiple CCs) for the anchor UE 120-1 in connection with the capability information indicating that the anchor UE 120-1 supports UE cooperation between the anchor UE 120-1 and the companion UE 120-2 via TB forwarding or PDCP packets forwarding. In some examples, in a case in which the capability information indicates that the anchor UE 120-1 supports UE cooperation between the anchor UE 120-1 and the companion UE 120-2 via TB forwarding or PDCP packets forwarding, the network node 110 may not configure a relaxed BB processing timeline for the anchor UE 120-1. In such example, the CA configuration may indicate a default (non-relaxed) value for the BB processing time parameter N1.

In some aspects, the determination of whether to approve/configure CA for the anchor UE 120-1 may be based at least in part on the cooperation between the anchor UE 120-1 and the companion UE 120-2 and the availability of the companion UE 120-2 to process transmissions on the additional CC (e.g., the SCC). In some aspects, the determination of whether to approve/configure CA for the anchor UE 120-1 may be based at least in part on (e.g., may be a function of) the sidelink conditions reported by the anchor UE 120-1 (e.g., in the capability information). For example, the network node 110 may configure the anchor UE 120-1 with multiple CCs if the sidelink latency and/or throughput conditions are ideal (e.g., low latency and high throughput), and the network node 110 may configure the anchor UE 120-1 to fall back to one CC if the sidelink latency and/or throughput conditions are non-ideal. In such examples, the network node 110 may determine that the sidelink latency and/or throughput conditions are ideal in connection with the sidelink latency being less than or equal to a latency threshold and/or the sidelink throughput being greater than or equal to a throughput threshold.

As further shown in FIG. 8A, and by reference number 820, the anchor UE 120-1 may transmit, and the network node 110 may receive, a hybrid automated repeat request (HARQ) acknowledgement (ACK) in response to receiving the configuration of CA for the anchor UE 120-1. For example, the anchor UE 120-1 may transmit the HARQ ACK to acknowledge that successful receipt and decoding of the RRC connection reconfiguration message including the configuration of CA for the anchor UE 120-1. As shown by reference number 825, the network node 110 may perform network reconfiguration for the CA. For example, the network node 110 may perform network reconfiguration over the PCC and the SCC configured for the anchor UE 120-1. The network node 110 may perform the network reconfiguration over the PCC and the SCC configured for the anchor UE 120-1 in response to receiving the HARQ ACK acknowledging receipt of the configuration of CA for the anchor UE 120-1.

As further shown in FIG. 8A, and by reference number 830, the anchor UE 120-1 and the companion UE 120-2 may communicate via one or more sidelink communications to configure CA for the UEs in accordance with the configuration of CA received by the anchor UE 120-1. For example, the anchor UE 120-1 and the companion UE 120-2 may perform UE reconfiguration over sidelink. The configuration of CA for the UEs (e.g., the UE reconfiguration over the sidelink) may configure the anchor UE 120-1 to receive downlink communications (e.g., PDSCH communications) via the PCC and the companion UE 120-2 to receive downlink communications (e.g., PDSCH communications) via the SCC. In some examples, the anchor UE 120-1 may transmit, and the companion UE 120-2 may receive, the CA configuration (or configuration information included in the CA configuration) via a sidelink communication. For example, the anchor UE 120-1 may transmit, and the companion UE 120-2 may receive, a sidelink UE reconfiguration message that includes the RRC connection reconfiguration message (including the CA configuration) received from the network node 110 or CA configuration information included in the RRC connection reconfiguration message received from the network node 110. In some examples, the companion UE 120-2 may transmit, and the anchor UE 120-1 may receive, an acknowledgement (e.g., a HARQ ACK) indicating that the companion UE 120-2 has received the CA configuration information (e.g., the sidelink UE reconfiguration message including the CA configuration information), and/or a UE reconfiguration complete message indicating successful completion of the reconfiguration of the companion UE 120-2.

As further shown in FIG. 8A, and by reference number 835, the anchor UE 120-1 may transmit, and the network node 110 may receive, a confirmation message indicating that the configuration of the anchor UE 120-1 is complete. For example, the confirmation message may be an RRC connection reconfiguration complete message indicating the reconfiguration of the anchor UE 120-1, in response to receiving the RRC connection reconfiguration message, is complete. The anchor UE 120-1 may transmit the confirmation message (e.g., the RRC connection reconfiguration complete message) once the anchor UE 120-1 and the companion UE 120-2 have both successfully completed UE reconfiguration responsive to the CA configuration.

In some examples, the anchor UE 120-1 may transmit, and the network node 110 may receive, a scheduling request (SR) requesting uplink resources to transmit the confirmation message (e.g., the RRC connection reconfiguration complete message). The network node 110 may then transmit, and the anchor UE 120-1 may receive, an uplink grant (e.g., DCI type 0) indicating allocating uplink resources to be used by the anchor UE 120-1. The anchor UE 120-1 may then transmit the confirmation message (e.g., the RRC connection reconfiguration complete message) using the uplink resources indicated in the uplink grant.

As further shown in FIG. 8A, and by reference number 840, the network node 110 may transmit, and the anchor UE 120-1 may receive, an activation command that activates the configured CA for the anchor UE 120-1. For example, the activation command may be included in a MAC-CE. The activation command may activate the PCC and the SCC configured for the anchor UE 120-1 by the CA configuration.

As further shown in FIG. 8A, and by reference number 845, the anchor UE 120-1 and the companion UE 120-2 may communicate via one or more sidelink communications to activate the CA for the anchor UE 120-1 and the companion UE 120-2. For example, the anchor UE 120-1 and the companion UE 120-2 may perform UE reconfiguration over the sidelink in response to the anchor UE 120-1 receiving the activation command. In some examples, the anchor UE 120-1 may transmit, and the companion UE 120-2 may receive, the activation command (or information included in the activation command) via a sidelink communication. For example, the anchor UE 120-1 may transmit, and the companion UE 120-2 may receive, a sidelink UE reconfiguration message that includes the activation command received from the network node 110 or information included in the activation command. In some examples, the companion UE 120-2 may transmit, and the anchor UE 120-1 may receive, an acknowledgement (e.g., a HARQ ACK) indicating that the companion UE 120-2 has received the activation command (e.g., the sidelink UE reconfiguration message including the activation command or the information included in the activation command) and/or a UE reconfiguration complete message indicating successful completion of the reconfiguration of the companion UE 120-2.

As further shown in FIG. 8A, and by reference number 850, the network node 110 may transmit downlink communications (e.g., PDSCHs) via the PCC (e.g., first carrier) and the SCC (e.g., second carrier). In some aspects, the network node 110 may transmit, and the anchor UE 120-1 may receive, one or more first downlink communications via the PCC. The network node 110 may transmit, and the companion UE 120-2 may receive, one or more second downlink communications via the SCC. In some examples, the first downlink communications transmitted via the PCC and the second downlink communications transmitted via the SCC may include data of a traffic flow (e.g., a QoS traffic flow or an SDF) that is directed to the anchor UE 120-1.

In some aspects, in a case in which the UE cooperation between the anchor UE 120-1 and the companion UE 120-2 uses IQ samples forwarding, the one or more first downlink communications transmitted via the PCC may include first IQ samples of a first BW of a PDSCH, and the one or more second downlink communications may include second IQ samples of a second BW of the PDSCH. In this case, the first IQ samples and the second IQ samples may be part of a same TB or different TBs. In some aspects, in a case in which the UE cooperation between the anchor UE 120-1 and the companion UE 120-2 uses TB forwarding or PDCP packets forwarding, the one or more first downlink communications may include a first PDSCH transmitted via the PCC, and the one or more second downlink communications may include a second PDSCH transmitted via the SCC. In this case, the first PDSCH transmitted via the PCC and the second PDSCH transmitted via the SCC may be FDMed.

As further shown in FIG. 8A, and by reference number 855, the companion UE 120-2 may forward the one or more second downlink communications received via the SCC (or data included in the one or more second downlink communications) to the anchor UE 120-1 via one or more sidelink communications. The anchor UE 120-1 may receive the one or more second downlink communications (or the data included in the one or more second downlink communications) forwarded by the companion UE 120-2.

In some aspects, the anchor UE 120-1 may receive the one or more second downlink communications via IQ samples forwarding from the companion UE 120-2. In such examples, the companion UE 120-2 may perform RF operations to receive IQ samples transmitted by the network node 110 via the SCC and forward the IQ samples transmitted via the SCC to the anchor UE 120-1 (e.g., via the sidelink interface). The anchor UE 120-1 may perform PHY layer processing, including BB processing, for the IQ samples transmitted via the SCC and forwarded to the anchor UE 120-1 by the companion UE 120-2, as well as IQ samples transmitted via the PCC by the network node 110 and received by the anchor UE 120-1. In such examples, the anchor UE 120-1 may perform the BB processing for the first downlink communications (e.g., the IQ samples received from the network node 110 via the PCC) and the second downlink communications (e.g., the IQ samples transmitted via the SCC and received via forwarding from the companion UE 120-2) in accordance with a relaxed BB processing timeline (e.g., in accordance with a relaxed value for the BB processing time parameter N1 indicated in the CA configuration).

In some aspects, the anchor UE 120-1 may receive the one or more second downlink communications via TB forwarding or PDCP packets forwarding from the companion UE 120-2. In such examples, the companion UE 120-2 may perform lower layer processing (e.g., PHY layer processing for MAC level TB forwarding; or PHY layer processing, MAC layer processing, and RLC layer processing for PDCP packets forwarding) for the one or more second downlink communications, and the companion UE 120-2 may forward one or more TBs or one or more PDCP packets to the anchor UE 120-1.

FIG. 8C shows an example 880 of CA for a RedCap UE (e.g., the anchor UE 120-1) with UE cooperation. In example 880, the UE cooperation between the anchor UE 120-1 and the companion UE 120-2 uses TB forwarding (e.g., MAC level forwarding). As shown in FIG. 8C, the traffic split for traffic transmitted via the PCC and traffic transmitted via the SCC may occur at the PHY layer of the network node 110. As shown by reference number 882, the network node 110 (e.g., a first PHY layer of the network node 110) may transmit first data of a traffic flow (e.g., a QoS flow or an SDF) via the PCC. The anchor UE 120-1 may receive the first data transmitted via the PCC. As shown by reference number 884, the network node 110 (e.g., a second PHY layer of the network node 110) may transmit second data of the traffic flow via the SCC. The companion UE 120-2 may receive the second data transmitted via the SCC. As shown by reference number 886, the companion UE 120-2 may perform PHY layer processing (e.g., PHY layer decoding and/or BB processing) for the second data transmitted by the network node 110 via the SCC. As shown by reference number 888, the companion UE 120-2 may forward, to the anchor UE 120-1 via the sidelink interface, MAC level data (e.g., one or more TBs) resulting from the PHY layer processing of the second data. The anchor UE 120-1 may receive, via the sidelink interface, the MAC level data (e.g., one or more TBs) forwarded to the anchor UE 120-1 by the companion UE 120-2. The anchor UE 120-1 may perform PHY layer processing for the first data received from the network node 110 via the PCC, and the anchor UE 120-1 may perform MAC layer processing for the MAC level data (e.g., one or more TBs) forwarded by the companion UE 120-2 as well as the first data received from the network node 110 (e.g., after performing the PHY layer processing). The anchor UE 120-1 may then perform RLC layer processing, PDCP layer processing, and SDAP layer processing for the data (e.g., the combined first and second data).

As indicated above, FIGS. 8A-8C are provided as examples. Other examples may differ from what is described with respect to FIGS. 8A-8C.

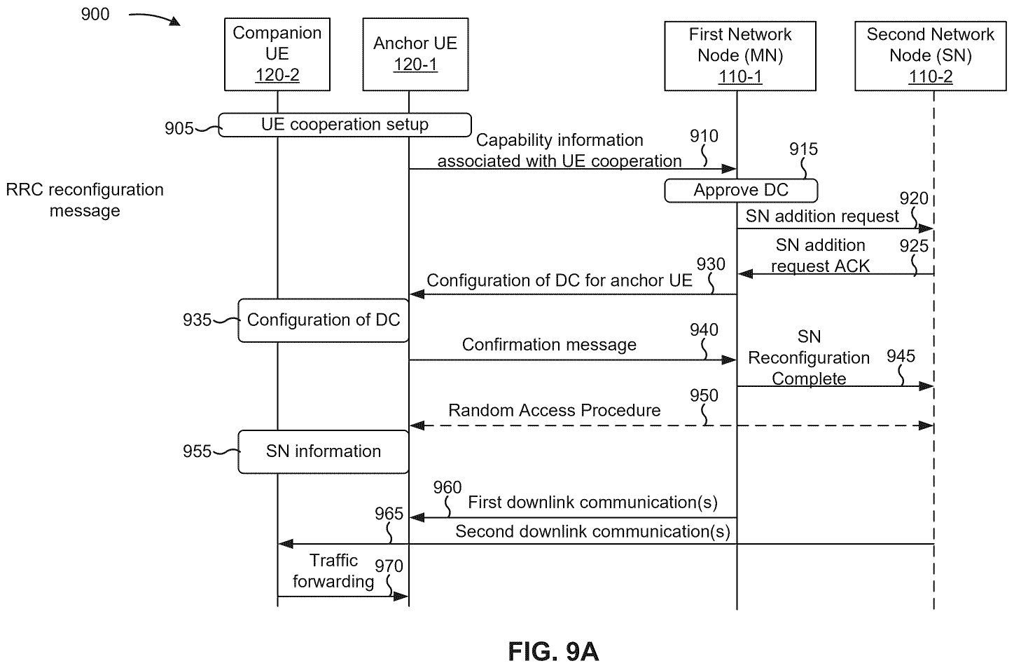

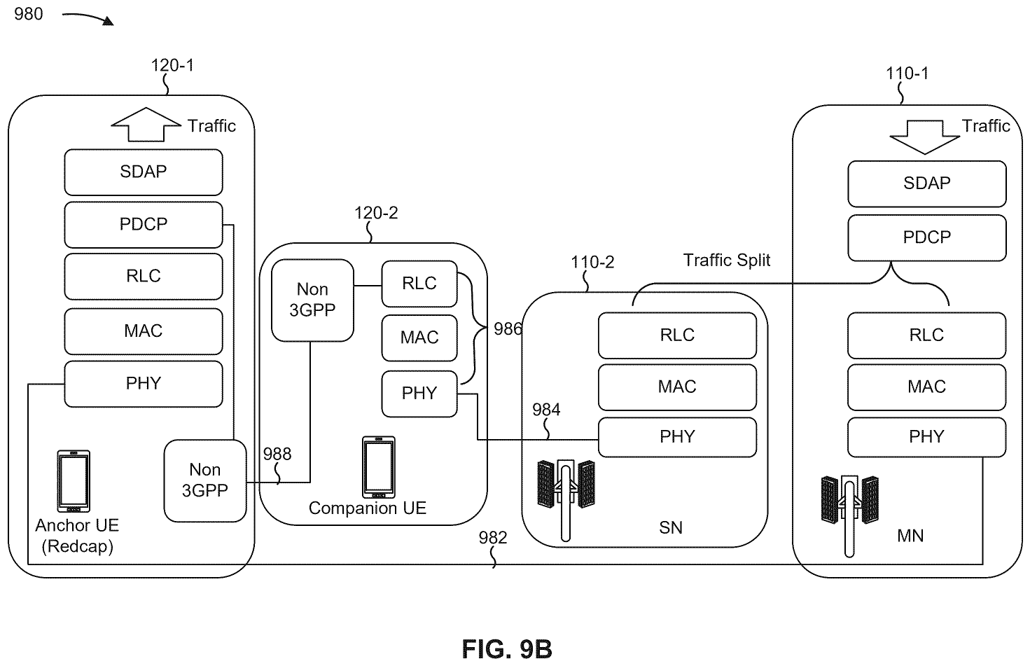

FIGS. 9A-9B are diagrams illustrating examples associated with DC for a UE with UE cooperation, in accordance with the present disclosure. As shown in FIG. 9A, example 900 includes a first network node 110-1, a second network node 110-2, an anchor UE 120-1, and a companion UE 120-2. In some aspects, the first network node 110-1, the second network node 110-2, the anchor UE 120-1, and the companion UE 120-2 may be included in a wireless communication network, such as wireless communication network 100. In some aspects, the anchor UE 120-1 may be a RedCap UE. For example, the anchor UE 120-1 may be an XR device (e.g., AR glasses or a VR headset) or a wearable device (e.g., a smartwatch or another type of wearable device), among other examples. In some aspects, the first network node 110-1 may be an MN and the second network node 110-2 may be an SN for dual connectivity communications with the anchor UE 120-1 and/or the companion UE 120-2.

In some aspects, the anchor UE 120-1 and the companion UE 120-2 may communicate via sidelink communications over a sidelink interface. In some aspects, sidelink communications described in connection with FIGS. 8A-8C may be NR sidelink communications over an NR sidelink interface (e.g., a PC5 interface). In some aspects, the sidelink communications described in connection with FIGS. 8A-8C may be wireless communications over another type of sidelink interface (e.g., a non-3GPP sidelink interface), such as UWB, Wi-Fi, or a PAN (e.g., Bluetooth or the like), among other examples. In some aspects, the sidelink communications described in connection with FIGS. 9A-9B may be communications over a wired connection, such as a USB connection or the like.

As shown in FIG. 9A, and by reference number 905, the anchor UE 120-1 and the companion UE 120-2 may set up UE cooperation between the anchor UE 120-1 and the companion UE 120-2. The anchor UE 120-1 and the companion UE 120-2 may communicate with each other via one or more sidelink communications to establish (or set up) the UE cooperation between the anchor UE 120-1 and the companion UE 120-2. In some aspects, the anchor UE 120-1 and the companion UE 120-2 may perform a pairing procedure to establish the UE cooperation between the anchor UE 120-1 and the companion UE 120-2.

In some aspects, the anchor UE 120-1 and the companion UE 120-2 may communicate to determine a type of UE cooperation supported by the anchor UE 120-1 and the companion UE 120-2. For example, the companion UE 120-2 may transmit (via the sidelink interface), and the anchor UE 120-1 may receive, an indication of a type of UE cooperation supported by the companion UE 120-2 (or multiple types of UE cooperation supported by the companion UE 120-2). The type of UE cooperation may correspond to a type of traffic forwarding to be performed by the companion UE 120-2. For example, the companion UE 120-2 may indicate, to the anchor UE 120-1, whether the companion UE 120-2 supports UE cooperation via IQ samples forwarding, TB forwarding, and/or PDCP forwarding. In some aspects, the companion UE 120-2 may transmit, and the anchor UE 120-1 may receive, an indication of a UE identifier of the companion UE 120-2.

As further shown in FIG. 9A, and by reference number 910, the anchor UE 120-1 may transmit, and the first network node 110-1 may receive, capability information associated with the UE cooperation between the anchor UE 120-1 and the companion UE 120-2. In some aspects, the capability information associated with the UE cooperation may be included in an anchor UE report (or multiple anchor UE reports) transmitted from the anchor UE 120-1 to the first network node 110-1. For example, the anchor UE 120-1 may transmit, and the first network node 110-1 may receive, a semi-static report (or message) (e.g., via RRC signaling) that includes some or all of the capability information associated with the UE cooperation. Additionally, or alternatively, the UE may transmit, and the first network node 110-1 may receive, a dynamic report (e.g., via a MAC-CE) that includes some or all of the capability information associated with the UE cooperation. In some aspects, the capability information associated with the UE cooperation may be included in any type of report or message transmitted from the anchor UE 120-1 to the first network node 110-1. For example, the capability information may be included in a semi-static UE capability report, a dynamic UE capability report, UE assistance information, or a MAC-CE, among other examples.

In some aspects, the capability information may indicate a RedCap UE capability. That is, the capability information may indicate that the anchor UE 120-1 is a RedCap UE. In some aspects, the capability information indicates a UE cooperation capability (or UE cooperation ability). For example, the UE cooperation capability may include an indication that the anchor UE 120-1 supports UE cooperation (e.g., with the companion UE 120-2) and/or an indication of a type (or types) of UE cooperation (e.g., UE cooperation via IQ samples forwarding, TB forwarding, or PDCP packets forwarding) supported by the anchor UE 120-1. In some aspects, the capability information may indicate the UE identifier of the companion UE 120-2. In some aspects, the capability information may indicate a request for DC approval.

In some aspects, the capability information may indicate the UE cooperation capability (e.g., an indication that the anchor UE 120-1 supports UE cooperation and/or an indication of a type of UE cooperation supported by the anchor UE 120-1) and an availability of the companion UE 120-2 (e.g., an availability of the companion UE 120-2 to process additional transmissions for the anchor UE 120-1 on an additional serving cell). The availability of the companion UE 120-2 may be based on or otherwise associated with sidelink conditions between the anchor UE 120-1 and the companion UE 120-2. In some aspects, the capability information may indicate one or more sidelink conditions (e.g., one or more sidelink channel measurements) between the anchor UE 120-1 and the companion UE 120-2. In some examples, the anchor UE 120-1 may periodically report sidelink channel measurements to the first network node 110-1. In some other examples, the anchor UE 120-1 may indicate the sidelink channel measurements to the first network node 110-1 via aperiodic reporting. For example, the aperiodic reporting may be based at least in part on the anchor UE 120-1 detecting a change in the sidelink conditions (e.g., a change in the sidelink conditions indicative of a problem with the sidelink conditions, or a change in the sidelink conditions indicative of an improvement or resolution of a problem with the sidelink conditions).

In some aspects, the capability information may indicate that the anchor UE 120-1 supports UE cooperation between the anchor UE 120-1 and the companion UE 120-2 via TB forwarding or PDCP packets forwarding. In some aspects, the capability information may indicate that the anchor UE 120-1 supports UE cooperation between the anchor UE 120-1 and the companion UE 120-2 via IQ samples forwarding. In some examples, in a case in which the capability information indicates that the anchor UE 120-1 supports UE cooperation via IQ samples forwarding, the capability information may also indicate a buffer capability of the anchor UE 120-1. For example, the buffer capability may indicate whether the anchor UE 120-1 has a sufficient TD or FD buffer size to handle processing of a larger PDSCH BW, as compared with a reduced BW associated with the anchor UE 120-1. In some aspects, in a case in which the capability information indicates that the anchor UE 120-1 supports UE cooperation via IQ samples forwarding, the capability information may indicate whether the anchor UE 120-1 has a large enough buffer size to store IQ samples of multiple serving cells. For example, the capability information may indicate that the buffer capability of the anchor UE 120-1 is sufficient for storing IQ samples of multiple serving cells. Additionally, or alternatively, in a case in which the capability information indicates that the anchor UE 120-1 supports UE cooperation via IQ samples forwarding, the capability information may indicate a request for a relaxed BB processing time.

As further shown in FIG. 9A, and by reference number 915, the first network node 110-1 (e.g., the MN) may determine to approve DC for the anchor UE 120-1 based at least in part on the capability information associated with the UE cooperation between the anchor UE 120-1 and the companion UE 120-2. Without UE cooperation, the baseline scheme may be one cell (e.g., no DC) for a RedCap UE. In some aspects, the first network node 110-1 may approve DC for a RedCap UE (e.g., the anchor UE 120-1) in connection with receiving the capability information associated with UE cooperation between the RedCap UE (e.g., the anchor UE 120-1) and a companion UE (e.g., the companion UE 120-2). That is, enabling DC for the anchor UE 120-1 (e.g., a RedCap UE) may be conditional on the UE cooperation between the anchor UE 120-1 and the companion UE 120-2. For example, in connection with the capability information indicating support for UE cooperation between the anchor UE 120-1 and the companion UE 120-2, first network node 110-1 may determine to approve DC for the anchor UE 120-1. Accordingly, with UE cooperation between the anchor UE 120-1 and the companion UE 120-2, the anchor UE 120-1 may be configured (an activated) with two carriers (e.g., the PCC and the SCC).

In some aspects, in a case in which the capability information indicates that the anchor UE 120-1 supports UE cooperation between the anchor UE 120-1 and the companion UE 120-2 via IQ samples forwarding, the determination of whether to approve/configure DC for the anchor UE 120-1 may be based at least in part on the indication, in the capability information, of the buffer capability or the anchor UE 120-1. In such examples, the first network node 110-1 may approve DC for the anchor UE 120-1 in connection with the capability information indicating that the buffer capability of the anchor UE 120-1 is sufficient for storing IQ samples of multiple serving cells. In some aspects, the first network node 110-1 may approve DC for the anchor UE 120-1 in connection with the capability information indicating that the anchor UE 120-1 supports UE cooperation between the anchor UE 120-1 and the companion UE 120-2 via TB forwarding or PDCP packets forwarding.

In some aspects, the determination of whether to approve DC for the anchor UE 120-1 may be based at least in part on the cooperation between the anchor UE 120-1 and the companion UE 120-2 and the availability of the companion UE 120-2 to process transmissions on an additional serving cell (e.g., a serving cell associated with the SN). In some aspects, the determination of whether to approve DC for the anchor UE 120-1 may be based at least in part on (e.g., may be a function of) the sidelink conditions reported by the anchor UE 120-1 (e.g., in the capability information). For example, the first network node 110-1 may approve DC for the anchor UE 120-1 if the sidelink latency and/or throughput conditions are ideal (e.g., low latency and high throughput), and the first network node 110-1 may configure the anchor UE 120-1 to fall back to one cell if the sidelink latency and/or throughput conditions are non-ideal. In such examples, the first network node 110-1 may determine that the sidelink latency and/or throughput conditions are ideal in connection with the sidelink latency being less than or equal to a latency threshold and/or the sidelink throughput being greater than or equal to a throughput threshold

As further shown in FIG. 9A, and by reference number 920, the first network node 110-1 (e.g., the MN) may transmit, and the second network node 110-2 (e.g., the SN) may receive an SN addition request. The first network node 110-1 may transmit the SN addition request to the second network node 110-2 to request that the second network node 110-2 serve as the SN for the anchor UE 120-1 in connection with the first network node 110-1 approving DC for the anchor UE 120-1. As shown by reference number 925, the second network node 110-2 (e.g., the SN) may transmit, and the first network node 110-1 (e.g., the MN) may receive, an SN addition request ACK. The SN addition request ACK may be an acknowledgement that the SN (e.g., the second network node 110-2) has successfully received the SN addition request. In some examples, the MN (e.g., the first network node 110-1) may transmit an Xn-U address indication message to the SN (e.g., the second network node 110-2) after receiving the SN addition request ACK.

As further shown in FIG. 9A, and by reference number 930, the first network node 110-1 (e.g., the MN) may transmit, and the anchor UE 120-1 may receive, a configuration of DC (or DC configuration) for the anchor UE 120-1 based at least in part on the capability information associated with the UE cooperation between the anchor UE 120-1 and the companion UE 120-2. In some aspects, the configuration of CA for the anchor UE 120-1 may be transmitted to the anchor UE 120-1 via RRC signaling. For example, the configuration of CA for the anchor UE 120-1 may be included in an RRC reconfiguration message that is transmitted by the first network node 110-1 and received by the anchor UE 120-1. In some examples, the RRC reconfiguration message may be a message approving DC for the anchor UE 120-1 and indicating the DC configuration for the anchor UE 120-1. The configuration of DC for the anchor UE 120-1 may indicate the MN (e.g., the first network node 110-1) and the SN (e.g., the second network node 110-2) for DC communications associated with the anchor UE 120-1, as well as serving cell information for the MN and the SN. For example, the serving cell information may indicate a first serving cell (or first cell group) associated with the MN and a second serving cell (or second cell group) associated with the SN.

In some aspects, the first network node 110-1 may transmit the configuration of DC for the anchor UE 120-1 in connection with (e.g., responsive to) the determination to approve DC for the anchor UE 120-1 discussed in connection with reference number 915. In some aspects, in a case in which the capability information indicates that the anchor UE 120-1 supports UE cooperation between the anchor UE 120-1 and the companion UE 120-2 via IQ samples forwarding, the first network node 110-1 may configure a relaxed BB processing timeline for the anchor UE 120-1. In such examples, the DC configuration may indicate a relaxed value for a BB processing time parameter N1. In some aspects, in a case in which the capability information indicates that the anchor UE 120-1 supports UE cooperation between the anchor UE 120-1 and the companion UE 120-2 via TB forwarding or PDCP packets forwarding, the first network node 110-1 may not configure a relaxed BB processing timeline for the anchor UE 120-1. In such example, the DC configuration may indicate a default (non-relaxed) value for the BB processing time parameter N1.

As further shown in FIG. 9A, and by reference number 935, the anchor UE 120-1 and the companion UE 120-2 may communicate via one or more sidelink communications to configure DC for the UEs in accordance with the configuration of DC received by the anchor UE 120-1. For example, the anchor UE 120-1 and the companion UE 120-2 may perform UE reconfiguration over sidelink. The configuration of DC for the UEs (e.g., the UE reconfiguration over the sidelink) may configure the anchor UE 120-1 to receive downlink communications (e.g., PDSCH communications) transmitted from the MN (e.g., via the first serving cell associated with the MN) and the companion UE 120-2 to receive downlink communications (e.g., PDSCH communications) transmitted from the SN (e.g., via the second serving cell associated with the SN). In some examples, the anchor UE 120-1 may transmit, and the companion UE 120-2 may receive, the DC configuration (or configuration information included in the DC configuration) via a sidelink communication. For example, the anchor UE 120-1 may transmit, and the companion UE 120-2 may receive, a sidelink UE reconfiguration message that includes the RRC reconfiguration message (including the DC configuration) received from the first network node 110-1 or DC configuration information included in the RRC reconfiguration message received from the first network node 110-1. In some examples, the companion UE 120-2 may transmit, and the anchor UE 120-1 may receive, an acknowledgement (e.g., a HARQ ACK) indicating that the companion UE 120-2 has received the DC configuration information (e.g., the sidelink UE reconfiguration message including the DC configuration information), and/or a UE reconfiguration complete message indicating successful completion of the reconfiguration of the companion UE 120-2.

As further shown in FIG. 8A, and by reference number 940, the anchor UE 120-1 may transmit, and the first network node 110-1 (e.g., the MN) may receive, a confirmation message indicating that the configuration of the anchor UE 120-1 is complete. For example, the confirmation message may be an RRC reconfiguration complete message indicating the reconfiguration of the anchor UE 120-1, in response to receiving the RRC reconfiguration message, is complete. The anchor UE 120-1 may transmit the confirmation message (e.g., the RRC reconfiguration complete message) once the anchor UE 120-1 and the companion UE 120-2 have both successfully completed UE reconfiguration responsive to the DC configuration.

As shown by reference number 945, the first network node 110-1 (e.g., the MN) may transmit, and the second network node 110-2 (e.g., the SN) may receive, an SN reconfiguration complete message. The first network node 110-1 may transmit the SN reconfiguration complete message to the second network node 110-2 responsive to the first network node 110-1 receiving the confirmation message (e.g., the RRC reconfiguration complete message) from the anchor UE 120-1.

As further shown in FIG. 9A, and by reference number 950, the anchor UE 120-1 may perform a random access procedure to establish a connection (e.g., an RRC connection) with the second network node 110-2 (e.g., the SN). For example, the anchor UE 120-1 may perform a four-step random access procedure or a two-step random access procedure to establish the connection with the second network node 110-2. In some examples, the random access procedure may be a contention-free random access (CFRA) procedure or a contention-based random access (CBRA) procedure. The anchor UE 120-1 may obtain SN information (e.g., system information and/or other information associated with the SN) during the random access procedure (e.g., in one or more random access channel (RACH) communications received from the second network node 110-2) and/or after establishing the connection with the second network node 110-2.

As further shown in FIG. 9A, and by reference number 955, the anchor UE 120-1 and the companion UE 120-2 may communicate via one or more sidelink communications to share SN information. For example, the anchor UE 120-1 may transmit, and the companion UE 120-2 may receive, SN information (e.g., system information and/or other information associated with the SN) obtained by the anchor UE 120-1 during the random access procedure and/or after establishing the connection with the second network node 110-2. In some examples, the anchor UE 120-1 may transmit, and the companion UE 120-2 may receive, a sidelink UE reconfiguration message that includes the SN information. In some aspects, the SN information may enable the companion UE 120-2 to establish a connection (e.g., an RRC connection) with the SN (e.g., the second network node 110-2) and/or enable the companion UE 120-2 to monitor for and receive downlink communications from the SN (e.g., the second network node 110-2). In some examples, the companion UE 120-2 may transmit, and the anchor UE 120-1 may receive, an acknowledgement (e.g., a HARQ ACK) indicating that the companion UE 120-2 has received the SN information (e.g., the sidelink UE reconfiguration message including the SN information), and/or a UE reconfiguration complete message indicating successful completion of the reconfiguration of the companion UE 120-2.

In some examples, the MN (e.g., the first network node 110-1) transmit, to the SN (e.g., the second network node 110-2), additional messages and/or information associated with DC communications for the anchor UE 120-1. For example, the MN may transmit an SN status transfer message to the SN, and/or the MN may forward, to the SN, data (received from a user plane function (UPF) of a core network) associated with SN terminated bearers or QoS flows moved from the MN. In some examples, the MN (e.g., the first network node 110-1) and the SN (e.g., the second network node 110-2) may communicate with the core network to perform a protocol data unit (PDU) session path update procedure. For example, the PDU session path update procedure may include the MN transmitting a PDU session resource modify indication to an AMF of the core network; bearer modification performed by the AMF the UPF; the MN receiving an end marker packet from the UPF and forwarding the end marker packet to the SN; and the MN receiving a PDU session modification confirmation from the AMF.

As further shown in FIG. 9A, and by reference number 960, the first network node 110-1 (e.g., the MN) may transmit, and the anchor UE 120-1 may receive, one or more first downlink communications (e.g., PDSCHs) via the first serving cell associated with the MN. As shown by reference number 965, the second network node 110-2 (e.g., the SN) may transmit, and the companion UE 120-2 may receive, one or more second downlink communications (e.g., PDSCHs) via the second serving cell associated with the SN. In some examples, the first downlink communications transmitted from the MN (e.g., via the first serving cell) and the second downlink communications transmitted from the SN (e.g., via the second serving cell) may include data of a traffic flow (e.g., a QoS traffic flow or an SDF) that is directed to the anchor UE 120-1.

In some aspects, in a case in which the UE cooperation between the anchor UE 120-1 and the companion UE 120-2 uses IQ samples forwarding, the one or more first downlink communications transmitted from the MN (e.g., via the first serving cell) may include first IQ samples of a first BW of a PDSCH, and the one or more second downlink communications transmitted from the SN (e.g., via the second serving cell) may include second IQ samples of a second BW of the PDSCH. In this case, the first IQ samples and the second IQ samples may be part of a same TB or different TBs. In some aspects, in a case in which the UE cooperation between the anchor UE 120-1 and the companion UE 120-2 uses TB forwarding or PDCP packets forwarding, the one or more first downlink communications may include a first PDSCH transmitted by the MN via the first serving cell, and the one or more second downlink communications may include a second PDSCH transmitted by the SN via the second serving cell.

As further shown in FIG. 9A, and by reference number 970, the companion UE 120-2 may forward the one or more second downlink communications received from the SN via the second serving cell (or data included in the one or more second downlink communications) to the anchor UE 120-1 via one or more sidelink communications. The anchor UE 120-1 may receive the one or more second downlink communications (or the data included in the one or more second downlink communications) forwarded by the companion UE 120-2.

In some aspects, the anchor UE 120-1 may receive the one or more second downlink communications via IQ samples forwarding from the companion UE 120-2. In such examples, the companion UE 120-2 may perform RF operations to receive IQ samples transmitted by the SN via the second serving cell and forward the IQ samples transmitted via the second serving cell to the anchor UE 120-1 (e.g., via the sidelink interface). The anchor UE 120-1 may perform PHY layer processing, including BB processing, for the IQ samples transmitted by the SN via the second serving cell and forwarded to the anchor UE 120-1 by the companion UE 120-2, as well as IQ samples transmitted by the MN via the first serving cell and received by the anchor UE 120-1. In such examples, the anchor UE 120-1 may perform the BB processing for the first downlink communications (e.g., the IQ samples received from the MN via the first serving cell) and the second downlink communications (e.g., the IQ samples transmitted by the SN via the second serving cell and received via forwarding from the companion UE 120-2) in accordance with a relaxed BB processing timeline (e.g., in accordance with a relaxed value for the BB processing time parameter N1 indicated in the DC configuration).

In some aspects, the anchor UE 120-1 may receive the one or more second downlink communications via TB forwarding or PDCP packets forwarding from the companion UE 120-2. In such examples, the companion UE 120-2 may perform lower layer processing (e.g., PHY layer processing for MAC level TB forwarding; or PHY layer processing, MAC layer processing, and RLC layer processing for PDCP packets forwarding) for the one or more second downlink communications, and the companion UE 120-2 may forward one or more TBs or one or more PDCP packets to the anchor UE 120-1.

FIG. 9B shows an example 980 of DC for a RedCap UE (e.g., the anchor UE 120-1) with UE cooperation. In example 980, the UE cooperation between the anchor UE 120-1 and the companion UE 120-2 uses PDCP packets forwarding (e.g., PDCP level forwarding). As shown by reference number 982, the MN (e.g., the first network node 110-1) may transmit first data of a traffic flow (e.g., a QoS flow or an SDF) via the a first serving cell. The anchor UE 120-1 may receive the first data transmitted from the MN via the first serving cell. As shown by reference number 984, the SN (e.g., the second network node 110-2) may transmit second data of the traffic flow via a second serving cell. The companion UE 120-2 may receive the second data transmitted from the SN via the second serving cell. As shown in FIG. 9B, the traffic split for traffic transmitted by the MN via the first serving cell (e.g., the first data of the traffic flow) and traffic transmitted by the SN via the second serving cell (e.g., the second data of the traffic flow) may occur at the RLC layer. As shown by reference number 986, the companion UE 120-2 may perform PHY layer processing, MAC layer processing, and RLC layer processing for the second data transmitted by the SN via the second serving cell. As shown by reference number 988, the companion UE 120-2 may forward, to the anchor UE 120-1 via the sidelink interface, PDCP level data (e.g., PDCP packets) resulting from the PHY layer processing, MAC layer processing, and RLC layer processing of the second data. The anchor UE 120-1 may receive, via the sidelink interface, the PDCP level data (e.g., PDCP packets) forwarded to the anchor UE 120-1 by the companion UE 120-2. The anchor UE 120-1 may perform PHY layer processing, MAC layer processing, and RLC layer processing for the first data received from the MN via the first serving cell, and the anchor UE 120-1 may perform PDCP layer processing for the PDCP level data (e.g., PDCP packets) forwarded by the companion UE 120-2, as well as the first data received from the MN (e.g., after performing the PHY layer processing, MAC layer processing, and RLC layer processing). The anchor UE 120-1 may then perform SDAP layer processing for the data (e.g., the combined first and second data).

As indicated above, FIGS. 9A-9B are provided as examples. Other examples may differ from what is described with respect to FIGS. 9A-9B.

FIG. 10 is a diagram illustrating an example process 1000 performed, for example, at a UE or an apparatus of a UE, in accordance with the present disclosure. Example process 1000 is an example where the apparatus or the UE (e.g., UE 120, anchor UE 120-1) performs operations associated with DC or CA for a UE with cooperation.

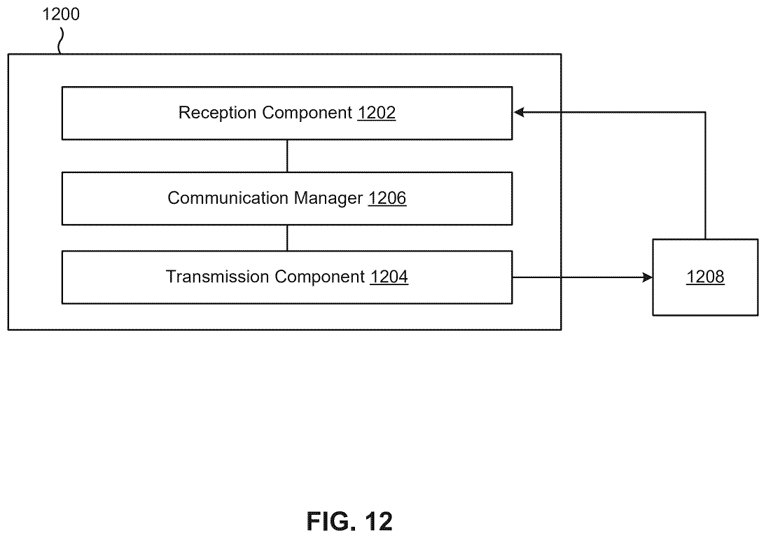

As shown in FIG. 10, in some aspects, process 1000 may include transmitting, to a network node, capability information associated with UE cooperation between the UE and a companion UE (block 1010). For example, the UE (e.g., using transmission component 1204 and/or communication manager 1206, depicted in FIG. 12) may transmit, to a network node, capability information associated with UE cooperation between the UE and a companion UE, as described above, for example in connection with reference number 805 of FIG. 8A and/or reference number 905 of FIG. 9A.

As further shown in FIG. 10, in some aspects, process 1000 may include receiving, from the network node, a configuration of at least one of CA or DC based at least in part on the capability information associated with the UE cooperation between the UE and the companion UE (block 1020). For example, the UE (e.g., using reception component 1202 and/or communication manager 1206, depicted in FIG. 12) may receive, from the network node, a configuration of at least one of CA or DC based at least in part on the capability information associated with the UE cooperation between the UE and the companion UE, as described above, for example in connection with reference number 815 of FIG. 8A and/or reference number 930 of FIG. 9A.

Process 1000 may include additional aspects, such as any single aspect or any combination of aspects described below and/or in connection with one or more other processes described elsewhere herein.

In a first aspect, the capability information indicates that the UE is RedCap UE.

In a second aspect, alone or in combination with the first aspect, the capability information indicates a UE identifier of the companion UE.

In a third aspect, alone or in combination with one or more of the first and second aspects, the capability information indicates that the UE supports UE cooperation between the UE and the companion UE via TB forwarding or PDCP packets forwarding.

In a fourth aspect, alone or in combination with one or more of the first through third aspects, the capability information indicates that the UE supports UE cooperation between the UE and the companion UE via IQ samples forwarding.

In a fifth aspect, alone or in combination with one or more of the first through fourth aspects, the capability information further indicates a buffer capability of the UE.

In a sixth aspect, alone or in combination with one or more of the first through fifth aspects, the capability information indicates that the buffer capability of the UE is sufficient for storing IQ samples of multiple CCs or multiple serving cells.

In a seventh aspect, alone or in combination with one or more of the first through sixth aspects, the capability information further indicates a request for a relaxed baseband processing time.

In an eighth aspect, alone or in combination with one or more of the first through seventh aspects, the capability information indicates a UE cooperation capability and an availability of the companion UE.

In a ninth aspect, alone or in combination with one or more of the first through eighth aspects, the capability information indicates one or more sidelink conditions between the UE and the companion UE, and the configuration of CA or DC is based at least in part on the one or more sidelink conditions.

In a tenth aspect, alone or in combination with one or more of the first through ninth aspects, the capability information includes a request for CA approval.

In an eleventh aspect, alone or in combination with one or more of the first through tenth aspects, the capability information includes a request for DC approval.

In a twelfth aspect, alone or in combination with one or more of the first through eleventh aspects, process 1000 includes receiving, from the network node, one or more first downlink communications associated with a first carrier or a first cell in accordance with the configuration, and receiving, via forwarding from the companion UE, one or more second downlink communications associated with a second carrier or a second cell in accordance with the configuration.

In a thirteenth aspect, alone or in combination with one or more of the first through twelfth aspects, receiving the one or more second downlink communications includes receiving the one or more second downlink communications via IQ samples forwarding from the companion UE.

In a fourteenth aspect, alone or in combination with one or more of the first through thirteenth aspects, process 1000 includes processing the one or more first downlink communications and the one or more second downlink communications in accordance with a relaxed baseband processing time.

In a fifteenth aspect, alone or in combination with one or more of the first through fourteenth aspects, receiving the one or more second downlink communications includes receiving the one or more second downlink communications via TB or PDCP packets forwarding from the companion UE.

In a sixteenth aspect, alone or in combination with one or more of the first through fifteenth aspects, the configuration is a configuration of CA for the UE.

In a seventeenth aspect, alone or in combination with one or more of the first through sixteenth aspects, the configuration is a configuration of DC for the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with DC or CA for a UE with cooperation.

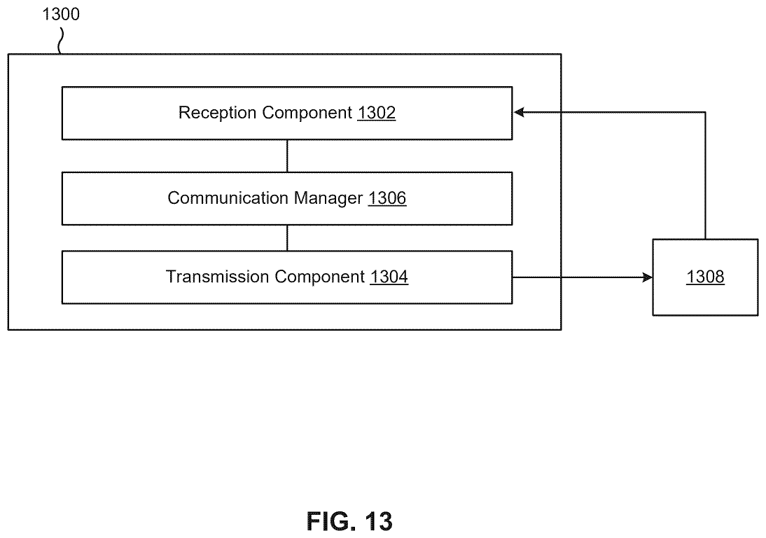

As shown in FIG. 11, in some aspects, process 1100 may include receiving, from a UE, capability information associated with UE cooperation between the UE and a companion UE (block 1110). For example, the network node (e.g., using reception component 1302 and/or communication manager 1306, depicted in FIG. 13) may receive, from a UE, capability information associated with UE cooperation between the UE and a companion UE, as described above, for example in connection with reference number 805 of FIG. 8A and/or reference number 905 of FIG. 9A.

As further shown in FIG. 11, in some aspects, process 1100 may include transmitting, to the UE, a configuration of at least one of CA or DC based at least in part on the capability information associated with the UE cooperation between the UE and the companion UE (block 1120). For example, the network node (e.g., using transmission component 1304 and/or communication manager 1306, depicted in FIG. 13) may transmit, to the UE, a configuration of at least one of CA or DC based at least in part on the capability information associated with the UE cooperation between the UE and the companion UE, as described above, for example in connection with reference number 815 of FIG. 8A and/or reference number 930 of FIG. 9A.

Process 1100 may include additional aspects, such as any single aspect or any combination of aspects described below and/or in connection with one or more other processes described elsewhere herein.

In a first aspect, the capability information indicates that the UE is a RedCap UE.

In a second aspect, alone or in combination with the first aspect, the capability information indicates a UE identifier of the companion UE.

In a third aspect, alone or in combination with one or more of the first and second aspects, the capability information indicates that the UE supports UE cooperation between the UE and the companion UE via TB forwarding or PDCP packets forwarding.

In a fourth aspect, alone or in combination with one or more of the first through third aspects, the capability information indicates that the UE supports UE cooperation between the UE and the companion UE via IQ samples forwarding.

In a fifth aspect, alone or in combination with one or more of the first through fourth aspects, the capability information further indicates a buffer capability of the UE.

In a sixth aspect, alone or in combination with one or more of the first through fifth aspects, the capability information indicates that the buffer capability of the UE is sufficient for storing IQ samples of multiple CCs or multiple serving cells.

In a seventh aspect, alone or in combination with one or more of the first through sixth aspects, the capability information further indicates a request for a relaxed baseband processing time.

In an eighth aspect, alone or in combination with one or more of the first through seventh aspects, the capability information indicates a UE cooperation capability and an availability of the companion UE.

In a ninth aspect, alone or in combination with one or more of the first through eighth aspects, the capability information indicates one or more sidelink conditions between the UE and the companion UE, and the configuration of CA or DC is based at least in part on the one or more sidelink conditions.

In a tenth aspect, alone or in combination with one or more of the first through ninth aspects, the capability information includes a request for CA approval.

In an eleventh aspect, alone or in combination with one or more of the first through tenth aspects, the capability information includes a request for DC approval.

In a twelfth aspect, alone or in combination with one or more of the first through eleventh aspects, process 1100 includes transmitting, to the UE, one or more first downlink communications associated with a first carrier or a first cell in accordance with the configuration, and transmitting, to the companion UE, one or more second downlink communications associated with a second carrier or a second cell in accordance with the configuration.

In a thirteenth aspect, alone or in combination with one or more of the first through twelfth aspects, the configuration is a configuration of CA for the UE.

In a fourteenth aspect, alone or in combination with one or more of the first through thirteenth aspects, the configuration is a configuration of DC for the UE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 8A-8C and 9A-9B. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the UE described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a network node, capability information associated with UE cooperation between the UE and a companion UE. The reception component 1202 may receive, from the network node, a configuration of at least one of CA or DC based at least in part on the capability information associated with the UE cooperation between the UE and the companion UE.

The reception component 1202 may receive, from the network node, one or more first downlink communications associated with a first carrier or a first cell in accordance with the configuration.

The reception component 1202 may receive, via forwarding from the companion UE, one or more second downlink communications associated with a second carrier or a second cell in accordance with the configuration.

The communication manager 1206 may process the one or more first downlink communications and the one or more second downlink communications in accordance with a relaxed baseband processing time.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 8A-8C and 9A-9B. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the network node described in connection with FIG. 1 and FIG. 2. Additionally, or alternatively, one or more components shown in FIG. 13 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive, from a UE, capability information associated with UE cooperation between the UE and a companion UE. The transmission component 1304 may transmit, to the UE, a configuration of at least one of CA or DC based at least in part on the capability information associated with the UE cooperation between the UE and the companion UE.

The transmission component 1304 may transmit, to the UE, one or more first downlink communications associated with a first carrier or a first cell in accordance with the configuration.

The transmission component 1304 may transmit, to the companion UE, one or more second downlink communications associated with a second carrier or a second cell in accordance with the configuration.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: transmitting, to a network node, capability information associated with UE cooperation between the UE and a companion UE; and receiving, from the network node, a configuration of at least one of carrier aggregation (CA) or dual connectivity (DC) based at least in part on the capability information associated with the UE cooperation between the UE and the companion UE.

Aspect 2: The method of Aspect 1, wherein the capability information indicates that the UE is a reduced capability (RedCap) UE.

Aspect 3: The method of any of Aspects 1-2, wherein the capability information indicates a UE identifier of the companion UE.

Aspect 4: The method of any of Aspects 1-3, wherein the capability information indicates that the UE supports UE cooperation between the UE and the companion UE via transport block (TB) forwarding or packet data convergence protocol (PDCP) packets forwarding.

Aspect 5: The method of any of Aspects 1-4, wherein the capability information indicates that the UE supports UE cooperation between the UE and the companion UE via in-phase and quadrature (IQ) samples forwarding.

Aspect 6: The method of Aspect 5, wherein the capability information further indicates a buffer capability of the UE.

Aspect 7: The method of Aspect 6, wherein the capability information indicates that the buffer capability of the UE is sufficient for storing IQ samples of multiple component carriers (CCs) or multiple serving cells.

Aspect 8: The method of any of Aspects 5-7, wherein the capability information further indicates a request for a relaxed baseband processing time.

Aspect 9: The method of any of Aspects 1-8, wherein the capability information indicates a UE cooperation capability and an availability of the companion UE.

Aspect 10: The method of any of Aspects 1-9, wherein the capability information indicates one or more sidelink conditions between the UE and the companion UE, and wherein the configuration of CA or DC is based at least in part on the one or more sidelink conditions.

Aspect 11: The method of any of Aspects 1-10, wherein the capability information includes a request for CA approval.

Aspect 12: The method of any of Aspects 1-11, wherein the capability information includes a request for DC approval.

Aspect 13: The method of any of Aspects 1-12, further comprising: receiving, from the network node, one or more first downlink communications associated with a first carrier or a first cell in accordance with the configuration; and receiving, via forwarding from the companion UE, one or more second downlink communications associated with a second carrier or a second cell in accordance with the configuration.

Aspect 14: The method of Aspect 13, wherein receiving the one or more second downlink communications comprises receiving the one or more second downlink communications via in-phase and quadrature (IQ) samples forwarding from the companion UE.

Aspect 15: The method of Aspect 14, further comprising: processing the one or more first downlink communications and the one or more second downlink communications in accordance with a relaxed baseband processing time.

Aspect 16: The method of Aspect 13, wherein receiving the one or more second downlink communications comprises receiving the one or more second downlink communications via transport block (TB) or packet data convergence protocol (PDCP) packets forwarding from the companion UE.

Aspect 17: The method of any of Aspects 1-16, wherein the configuration is a configuration of CA for the UE.

Aspect 18: The method of any of Aspects 1-17, wherein the configuration is a configuration of DC for the UE.

Aspect 19: A method of wireless communication performed by a network node, comprising: receiving, from a user equipment (UE), capability information associated with UE cooperation between the UE and a companion UE; and transmitting, to the UE, a configuration of at least one of carrier aggregation (CA) or dual connectivity (DC) based at least in part on the capability information associated with the UE cooperation between the UE and the companion UE.

Aspect 20: The method of Aspect 19, wherein the capability information indicates that the UE is a reduced capability (RedCap) UE.

Aspect 21: The method of any of Aspects 19-20, wherein the capability information indicates a UE identifier of the companion UE.

Aspect 22: The method of any of Aspects 19-21, wherein the capability information indicates that the UE supports UE cooperation between the UE and the companion UE via transport block (TB) forwarding or packet data convergence protocol (PDCP) packets forwarding.

Aspect 23: The method of any of Aspects 19-22, wherein the capability information indicates that the UE supports UE cooperation between the UE and the companion UE via in-phase and quadrature (IQ) samples forwarding.

Aspect 24: The method of Aspect 23, wherein the capability information further indicates a buffer capability of the UE.

Aspect 25: The method of Aspect 24, wherein the capability information indicates that the buffer capability of the UE is sufficient for storing IQ samples of multiple component carriers (CCs) or multiple serving cells.

Aspect 26: The method of any of Aspects 23-25, wherein the capability information further indicates a request for a relaxed baseband processing time.

Aspect 27: The method of any of Aspects 19-26, wherein the capability information indicates a UE cooperation capability and an availability of the companion UE.

Aspect 28: The method of any of Aspects 19-27, wherein the capability information indicates one or more sidelink conditions between the UE and the companion UE, and wherein the configuration of CA or DC is based at least in part on the one or more sidelink conditions.

Aspect 29: The method of any of Aspects 19-28, wherein the capability information includes a request for CA approval.

Aspect 30: The method of any of Aspects 19-29, wherein the capability information includes a request for DC approval.

Aspect 31: The method of any of Aspects 19-30, further comprising: transmitting, to the UE, one or more first downlink communications associated with a first carrier or a first cell in accordance with the configuration; and transmitting, to the companion UE, one or more second downlink communications associated with a second carrier or a second cell in accordance with the configuration.

Aspect 32: The method of any of Aspects 19-31, wherein the configuration is a configuration of CA for the UE.

Aspect 33: The method of any of Aspects 19-32, wherein the configuration is a configuration of DC for the UE.

Aspect 34: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-33.

Aspect 35: An apparatus for wireless communication at a device, the apparatus comprising one or more memories and one or more processors coupled to the one or more memories, the one or more processors configured to cause the device to perform the method of one or more of Aspects 1-33.

Aspect 36: An apparatus for wireless communication, the apparatus comprising at least one means for performing the method of one or more of Aspects 1-33.

Aspect 37: A non-transitory computer-readable medium storing code for wireless communication, the code comprising instructions executable by one or more processors to perform the method of one or more of Aspects 1-33.

Aspect 38: A non-transitory computer-readable medium storing a set of instructions for wireless communication, the set of instructions comprising one or more instructions that, when executed by one or more processors of a device, cause the device to perform the method of one or more of Aspects 1-33.

Aspect 39: A device for wireless communication, the device comprising a processing system that includes one or more processors and one or more memories coupled with the one or more processors, the processing system configured to cause the device to perform the method of one or more of Aspects 1-33.

Aspect 40: An apparatus for wireless communication at a device, the apparatus comprising one or more memories and one or more processors coupled to the one or more memories, the one or more processors individually or collectively configured to cause the device to perform the method of one or more of Aspects 1-33.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit, to a network node, capability information associated with UE cooperation between the UE and a companion UE; and
receive, from the network node, a configuration of at least one of carrier aggregation (CA) or dual connectivity (DC) based at least in part on the capability information associated with the UE cooperation between the UE and the companion UE.

2. The UE of claim 1, wherein the capability information indicates that the UE is a reduced capability (RedCap) UE.

3. The UE of claim 1, wherein the capability information indicates a UE identifier of the companion UE.

4. The UE of claim 1, wherein the capability information indicates that the UE supports UE cooperation between the UE and the companion UE via transport block (TB) forwarding or packet data convergence protocol (PDCP) packets forwarding.

5. The UE of claim 1, wherein the capability information indicates that the UE supports UE cooperation between the UE and the companion UE via in-phase and quadrature (IQ) samples forwarding.

6. The UE of claim 5, wherein the capability information indicates that a buffer capability of the UE is sufficient for storing IQ samples of multiple component carriers (CCs) or multiple serving cells.

7. The UE of claim 5, wherein the capability information further indicates a request for a relaxed baseband processing time.

8. The UE of claim 1, wherein the capability information indicates a UE cooperation capability and an availability of the companion UE.

9. The UE of claim 1, wherein the capability information indicates one or more sidelink conditions between the UE and the companion UE, and wherein the configuration of CA or DC is based at least in part on the one or more sidelink conditions.

10. The UE of claim 1, wherein the capability information includes a request for CA approval or a request for DC approval.

11. The UE of claim 1, wherein the one or more processors are further configured to cause the UE to:
receive, from the network node, one or more first downlink communications associated with a first carrier or a first cell in accordance with the configuration; and
receive, via forwarding from the companion UE, one or more second downlink communications associated with a second carrier or a second cell in accordance with the configuration.

12. The UE of claim 11, wherein the one or more processors, to cause the UE to receive the one or more second downlink communications, are configured to cause the UE to receive the one or more second downlink communications via in-phase and quadrature (IQ) samples forwarding from the companion UE.

13. The UE of claim 12, wherein the one or more processors are further configured to cause the UE to:
process the one or more first downlink communications and the one or more second downlink communications in accordance with a relaxed baseband processing time.

14. The UE of claim 11, wherein the one or more processors, to cause the UE to receive the one or more second downlink communications, are configured to cause the UE to receive the one or more second downlink communications via transport block (TB) or packet data convergence protocol (PDCP) packets forwarding from the companion UE.

15. The UE of claim 1, wherein the configuration is a configuration of CA for the UE.

16. The UE of claim 1, wherein the configuration is a configuration of DC for the UE.

17. A network node for wireless communication, comprising:
one or more memories; and
one or more processors, coupled to the one or more memories, configured to cause the network node to:
receive, from a user equipment (UE), capability information associated with UE cooperation between the UE and a companion UE; and
transmit, to the UE, a configuration of at least one of carrier aggregation (CA) or dual connectivity (DC) based at least in part on the capability information associated with the UE cooperation between the UE and the companion UE.

18. The network node of claim 17, wherein the capability information indicates that the UE is a reduced capability (RedCap) UE.

19. The network node of claim 17, wherein the one or more processors are further configured to cause the network node to:
transmit, to the UE, one or more first downlink communications associated with a first carrier or a first cell in accordance with the configuration; and
transmit, to the companion UE, one or more second downlink communications associated with a second carrier or a second cell in accordance with the configuration.

20. A method of wireless communication performed by a user equipment (UE), comprising:
transmitting, to a network node, capability information associated with UE cooperation between the UE and a companion UE; and
receiving, from the network node, a configuration of at least one of carrier aggregation (CA) or dual connectivity (DC) based at least in part on the capability information associated with the UE cooperation between the UE and the companion UE.
